(19) United States
(12) Patent Application Publication
(10) Pub. No.: US 2019/0093469 A1
(43) Pub. Date: Mar. 28, 2019

(54) Dynamic Reservoir Characterization

(71) Applicant: Schlumberger Technology Corporation, Sugar Land, TX (US)

(72) Inventors: Brennig Williams, Cardiff (GB); Marat Shaykhattarov, Abingdon (GB)

(21) Appl. No.: 16/140,383

(22) Filed: Sep. 24, 2018

Related U.S. Application Data
(60) Provisional application No. 62/562,485, filed on Sep. 24, 2017.

(51) Int. Cl. E21B 44/00; G06F 17/50; G06T 17/05

(52) U.S. Cl. CPC E21B 44/00; G06T 17/05; G06F 17/5009

(57) ABSTRACT

A method for operating a reservoir simulator includes performing a reservoir simulation based on a spatial reservoir model that represents a subterranean environment that includes a reservoir where, for a portion of the spatial reservoir model, the performing includes utilizing a phase model operational mode; based at least in part on a phase transition in the portion of the spatial reservoir model to a multi-phase region that includes a microemulsion, implementing a multi-phase operational mode; and, based at least in part on a phase transition in the portion of the spatial reservoir model from the multi-phase region to a different phase region, implementing the phase model operational mode for the portion of the spatial reservoir model.

### RELATED APPLICATIONS

This application claims priority to and the benefit of a US Provisional Application having Ser. No. 62/562,485, filed 24 Sep. 2017, which is incorporated by reference herein.

### BACKGROUND

A reservoir may be a subsurface body of rock that includes sufficient porosity and permeability to store and transmit fluids. As an example, sedimentary rock may possess more porosity than various types of igneous and metamorphic rocks. Sedimentary rock may form under temperature conditions at which hydrocarbons may be preserved. A reservoir may be a component of a so-called petroleum system. A geologic environment may be a sedimentary basin that may include one or more fluid reservoirs.

### SUMMARY

A method for operating a reservoir simulator includes performing a reservoir simulation based on a spatial reservoir model that represents a subterranean environment that includes a reservoir where, for a portion of the spatial reservoir model, the performing includes utilizing a phase model operational mode; based at least in part on a phase transition in the portion of the spatial reservoir model to a multi-phase region that includes a microemulsion, implementing a multi-phase operational mode; and, based at least in part on a phase transition in the portion of the spatial reservoir model from the multi-phase region to a different phase region, implementing the phase model operational mode for the portion of the spatial reservoir model. A system can include a processor; memory operatively coupled to the processor; and processor-executable instructions stored in the memory to instruct the system, the instructions including instructions to perform a reservoir simulation based on a spatial reservoir model that represents a subterranean environment that includes a reservoir where, for a portion of the spatial reservoir model, the reservoir simulation utilizes a phase model operational mode; based at least in part on a phase transition in the portion of the spatial reservoir model to a multi-phase region that includes a microemulsion, implement a multi-phase operational mode; and based at least in part on a phase transition in the portion of the spatial reservoir model from the multi-phase region to a different phase region, implement the phase model operational mode for the portion of the spatial reservoir model. One or more computer-readable storage media can include computer-executable instructions to instruct a computer, the instructions including instructions to: perform a reservoir simulation based on a spatial reservoir model that represents a subterranean environment that includes a reservoir where, for a portion of the spatial reservoir model, the reservoir simulation utilizes a phase model operational mode; based at least in part on a phase transition in the portion of the spatial reservoir model to a multi-phase region that includes a microemulsion, implement a multi-phase operational mode; and based at least in part on a phase transition in the portion of the spatial reservoir model from the multi-phase region to a different phase region, implement the phase model operational mode for the portion of the spatial reservoir model. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for modeling a geologic environment and various equipment associated with the geologic environment;

FIG. 2 illustrates an example of a sedimentary basin, an example of a method, an example of a formation, an example of a borehole, an example of a borehole tool, an example of a convention and an example of a system;

FIG. 3 illustrates examples of equations and an example of a plot;

FIG. 4 illustrates an example of a method;

FIG. 5 illustrates an example of a method;

FIG. 6 illustrates examples of pseudocodes;

FIG. 7 illustrates examples of graphics;

FIG. 8 illustrates examples of phase diagrams;

FIG. 9 illustrates examples of diagrams;

FIG. 10 illustrates examples of components mapping;

FIG. 11 illustrates an example of a method;

FIG. 12 illustrates an example of a scenario;

FIG. 13 illustrates an example plot;

FIG. 14 illustrates an example plot;

FIG. 15 illustrates an example plot;

FIG. 16 illustrates an example plot;

FIG. 17 illustrates an example plot;

FIG. 18 illustrates an example plot;

FIG. 19 illustrates an example plot;

FIG. 20 illustrates examples of graphical user interfaces (GUIs);

FIG. 21 illustrates an example of an operation and equipment; and

FIG. 22 illustrates example components of a system and a networked system.

### DETAILED DESCRIPTION

This description is not to be taken in a limiting sense, but rather is made merely for the purpose of describing the general principles of the implementations. The scope of the described implementations should be ascertained with reference to the issued claims.

A reservoir can be a subsurface body of rock that includes sufficient porosity and permeability to store and transmit fluids. A dynamic reservoir simulator, as a computational tool to characterize a reservoir based at least in part on field data (e.g., seismic data, satellite data, wellbore data, etc.), can simulate physical phenomena that can occur in a reservoir, which may be a reservoir in a sedimentary basin (e.g., a geologic environment). In reservoir simulation, multiphase flow effects through a porous medium (e.g. or porous media) may be determined via saturations that may, for example, characterize relative permeability of one phase given saturation of one or more other phases. As an example, tabulated functions for saturations may be prepared for various facies within a reservoir. In such an example, where a reservoir simulation uses a grid cell model, various cells within the grid cell model may be assigned common values (e.g., via values determined using tabulated functions, tabulated function values, etc.).

As an example, an oil recovery process can include one or more recovery phases, which can be categorized, for example, as primary, secondary, and tertiary recovery phases. In a primary oil recovery phase, oil can be driven by natural pressure of a reservoir. As an example, natural movement of oil may be enhanced with artificial lift techniques such as pumps (e.g., electric submersible pumps, etc.). As an example, an oil extraction range as to primary recovery may be from about 10 percent to about 20 percent of the oil available in the field. A secondary recovery phase may employ water in a process known as waterflooding to help recover oil from the field. Waterflooding can involve injection of water and/or steam that aims to displace oil and direct it to a wellbore (s). As an example, an additional 10 percent to about 30 percent recovery of oil from the available oil field may be possible via implementation of a secondary recovery phase. As to a tertiary oil recovery or enhanced oil recovery (EOR) phase, it may utilize one or more additional processes, which can be more complex as to types of equipment, materials, operation, etc. Proper application of one or more tertiary phase processes may enhance oil recovery to about 30 percent to about 60 percent of a total oil field.

As may be appreciated, water-based (e.g., including steam-based) techniques can introduce water into a field, which can be considered new water as water can already exist in a field. New water can complicate processing of recovered oil where a produced oil includes water, which may include an increasing fraction of water depending on one or more types of recovery phase processes utilized. For example, new water introduced during waterflooding can increase water fraction during recovery, which may demand separation of oil and water during further processing of produced oil fluid(s).

In the field of chemical enhanced oil recovery (chemical EOR), one or more types of chemicals can be used to increase a recovery factor of a field. Such chemicals may be referred to as chemical agents, which can include surface active agents, known as surfactants. Surfactants can lower surface tension (e.g., interfacial tension) between two liquids or between a liquid and a solid. Surfactants may act as detergents, wetting agents, emulsifiers, foaming agents, and dispersants.

As an example, in microemulsion forming recovery process, an oil reservoir can be flooded with water that includes surfactant and other additives. Such a solution may react with natural acids in trapped oil to facilitate microemulsion formation. Surfactant selection can play a role in determining what type of microemulsion or microemulsions form, which can help to diminish the interfacial tension (IFT) as to targeted oil.

As an example, where waterflooding has been successful, microemulsion flooding tends to be applicable; while, in instances where waterflooding has not readily benefited production, microemulsion flooding may still be employed and productive via microemulsion enhanced mobility.

As an example, a microemulsion process may aim to form a microemulsion slug that can travel in a reservoir from an injection well toward a production well. Formulation of a microemulsion slug for a particular reservoir can depend on various factors, including characteristics of a reservoir, which may be affected by one or more prior recovery processes (e.g., waterflooding, etc.). A microemulsion process can depend on one or more of, for example, temperature, salinity, crude oil type, etc.

Surfactants may be classified as natural, synthetic, organic, inorganic, etc. As an example, a surfactant can be amphiphilic with hydrophobic character and hydrophilic character where the surfactant can orient itself at the interface between a hydrophobic liquid and a hydrophilic liquid, where “hydrophilic” and “hydrophobic” can be relative terms with respect to the two liquids. As an example, consider water and oil where a portion of a surfactant that is hydrophilic associates with a portion of the water and where a portion of the surfactant that is hydrophobic associates with a portion of the oil. Where a gas phase is present such as air, hydrocarbon gas, etc., a portion of a surfactant may associate with the gas phase while, for example, another portion associates with a liquid phase.

A surfactant can be defined as a chemical that preferentially adsorbs at an interface, lowering the surface tension or interfacial tension between fluids or between a fluid and a solid. The term “surfactant” can encompass a multitude of materials that function as emulsifiers, dispersants, oil-wetters, water-wetters, foamers and defoamers. The type of surfactant behavior depends on structural groups of a molecule (e.g., or mixture of molecules). As an example, a hydrophile-lipophile balance (HLB) number can help to define the function that a molecular group will perform.

A HLB number can be on a scale of one to 40 according to the HLB system devised by Griffin. The HLB system is a semi-empirical method to predict what type of surfactant properties a molecular structure will provide. The HLB system is based on the concept that some molecules have hydrophilic groups, other molecules have lipophilic groups, and some have both. Weight percentage of each type of group on a molecule or in a mixture can help to predict what behavior the molecular structure will exhibit. Water-in-oil emulsifiers tend to have a low HLB numbers (e.g., around 4); solubilizing agents tend to have high HLB numbers; and oil-in-water emulsifiers tend to have intermediate to high HLB numbers.

An emulsion can be a dispersion of one immiscible liquid into another, which may be achieved, for example, through the use of one or more types of chemical agents. For example, a surfactant may be utilized to reduce the interfacial tension between two liquids to achieve some amount of stability (e.g., depending on factors such as temperature, pressure, flow, pH, etc.). With respect to oil and water, an oil-in-water (or direct) emulsion or a water-in-oil (or invert) emulsion may exist.

Emulsions may form when fluid filtrates or injected fluids and reservoir fluids (for example oil or brine) mix or, for example, when the pH of a producing fluid changes, such as after an acidizing treatment. Acidizing might change the pH from 6 or 7 to less than 4. Emulsions may be found in gravel packs and perforations, or inside a formation (e.g., a reservoir formation, etc.). Some types of emulsions break when a source of mixing energy is reduced. Some natural and artificial stabilizing agents, such as surfactants and small particle solids, may tend to keep fluids emulsified. Natural surfactants, created by bacteria or during the oil generation process, can be found in various waters and crude oils, while artificial surfactants can be part of one or more drilling, completion and/or stimulation fluids. As to solids that can help to stabilize emulsions, consider one or more of iron sulfide, paraffin, sand, silt, clay, asphalt, scale and corrosion products.

As mentioned, surfactants may be utilized as part of a chemical EOR operation, for example, by injecting chemical agents into a formation. One particular approach, surfactant flooding, achieves this by reducing the interfacial tension (IFT) between oil and water and mobilizing trapped oil on microscopic scale. As an example, surfactants utilized as part of a chemical EOR operation may include one or more petroleum sulfonates, one or more ethoxylated alcohol sulfates, etc.

As mentioned, surfactants may be classified as amphiphilic molecules that include hydrophobic and hydrophilic groups. This amphiphilic nature can reduce the IFT between oil and water and, depending on circumstances, may lead to formation of aggregates called micelles and a separate microemulsion (ME) phase, for example, consider a separate ME phase that includes oil or water or both. Therefore, mutual solubility of immiscible fluids can be achieved, as well as enhanced flow characteristics of the water-oil-microemulsion system (as IFT between water/oil and newly formed ME phase can be reduced).

The process of adding surfactant to a mixture of oil and water can result in complex phase state changes. Such complex phase behavior, along with the rapid reduction of IFT, can make dynamic reservoir characterization via a dynamic reservoir simulator more challenging. A dynamic reservoir simulator can utilize one or more types of models that describe physical phenomena. For example, consider the Arrhenius equation as a model that characterizes dynamic reactions with respect to temperature.

The Arrhenius equation can be utilized to determine a rate of a chemical reaction and, for example, to calculate an energy of activation. The Arrhenius equation may have some physical justification while some contend that it is a type of empirical relationship, which is supported by real-world data. As an example, the Arrhenius equation can be used to model the temperature variation of diffusion coefficients, population of crystal vacancies, creep rates, and various other thermally-induced processes/reactions.

As to mixtures of liquids that include oil and an aqueous medium, an increase in temperature can enhance the thermal energy of the mixture that may, for example, cause an oil droplet to vibrate and travel faster in Brownian motion within an aqueous medium, thus easier for an emulsion to flow. Based on the Arrhenius equation, there is an inverse relationship between the viscosity and the temperature:

η=ηₒ exp(EₐRT)

where ηₒ is a constant, Eₐ is the activation energy, T is the absolute temperature, and R is the gas constant (8.314 KJ mol⁻¹). Viscosities of formulations may decrease with an increase in temperature within a mixture that can be adequately described by the Arrhenius equation; noting that factors related to loose packing between polymer chains can cause more space for a polymer chain to slip through.

As an example, an emulsion may be a micro-emulsion or microemulsion (ME), which can be a dispersion made of water, oil (e.g., a water insoluble liquid), and surfactant(s) that is an isotropic and thermodynamically stable system with dispersed domain diameter varying approximately from 1 nm to 100 nm (e.g., consider a range from approximately 10 nm to approximately 50 nm). Such a definition may be an IUPAC definition. In a microemulsion the domains of the dispersed phase can be globular or interconnected (e.g., consider a bicontinuous microemulsion). As an example, an emulsion may be a macro-emulsion or macroemulsion where the average diameter of droplets in a macroemulsion can be close to one millimeter. As an example, a microemulsion can be a mixture where entities of a dispersed phase are stabilized by a surfactant and/or a surfactant-cosurfactant system (e.g., aliphatic alcohol, etc.).

A dynamic reservoir simulator that can characterize dynamic behavior of a reservoir, particularly where chemical EOR is utilized, can facilitate operational decision making as to various factors of development of a field. For example, output from a dynamical reservoir simulator can be utilized to determine amounts and/or types of chemical(s) to utilize for chemical EOR, when to and/or not to utilize one or more chemical(s) for chemical EOR, injection rate(s) of chemical(s), etc. As an example, decisions as to types of equipment, types of drilling, types of hydraulic fracturing, etc. may be based at least in part on output from a dynamic reservoir simulator that can characterize dynamic behavior of a reservoir based at least in part on data (e.g., survey data) and one or more models (e.g., that model physical phenomena, etc.).

As an example, simulator can include features of the UTCHEM simulator, which is a multicomponent, multiphase, three-dimensional chemical compositional reservoir simulation model simulator. In the UTCHEM simulator, flow and transport equations are as follows: a mass conservation equation for each chemical species; an overall mass conservation equation that yields a pressure equation when combined with a generalized Darcy's law; and an energy conservation equation. In the UTCHEM simulator, four phases can be modeled. The phases are a single component gas phase and up to three liquid phases—aqueous, oleic, and microemulsion—depending on the relative amounts and effective electrolyte concentration (salinity) of the surfactant/oil/water phase environment. In the UTCHEM simulator, accurate and realistic chemical flooding models the complex microemulsion phase behavior and the various properties associated with these phases (such as interfacial tension, relative permeability, capillary pressure, capillary desaturation and viscosity) and factors that determine the behavior of the species in these phases such as dispersion, adsorption and cation exchange. The resulting flow equations of the UTCHEM simulator are solved using a block-centered finite-difference scheme. The solution method is implicit in pressure and explicit in concentration (IMPES-like). A third-order spatial discretization is used and in order to increase the stability and robustness of the third-order method, a flux limiter based on the total-variation-diminishing scheme has been added. The UTCHEM simulator can be used to simulate laboratory and field scale processes such as water flooding, tracers in water, polymer, surfactant/polymer, profile control using gel, and high pH alkaline/surfactant/polymer. Some applications of a simulator such as the UTCHEM simulator include: surfactant flooding, high pH alkaline/surfactant/polymer flooding, polymer flooding, conformance control using polymer gels, tracer tests, formation damage, soil remediation, microbial enhanced oil recovery and surfactant/foam.

As an example, various features of the UTCHEM simulator may be utilized in the INTERSECT® simulator (Schlumberger Limited, Houston, Tex.). The INTERSECT® simulator (e.g., INTERSECT (IX)) can characterize dynamic reservoir behavior where there is a presence of a microemulsion phase, which may be present for one or more periods of time.

The INTERSECT® high-resolution reservoir simulator can provide for accuracy and efficiency in field development planning and risk mitigation. As an example, the INTERSECT® simulator may be utilized to characterize a reservoir as to one or more of the following: complex geological structures, highly heterogeneous formations, challenging wells and completion configurations, advanced production controls in terms of reservoir coupling and flexible field management.

A simulator such as the INTERSECT® simulator may be utilized to achieve gains in consistency and productivity, for example, through automation and/or cross-discipline integration. For example, one or more projects may be undertaken using the INTERSECT® simulator together with the PETREL® E&P software platform (Schlumberger Limited, Houston, Tex.). A system can provide an ability to define the structure and properties of a reservoir (e.g., using survey data, etc.), characterize fluids and rock physics, and output and implement a field development plan.

As an example, a method can include performing one or more integrated workflows through a framework such as the PETREL® E&P platform or framework. The PETREL® E&P software platform can integrate multidisciplinary workflows as associated with the INTERSECT® simulator, which can provide data flows and graphical user interfaces for reservoir engineering. The PETREL® platform supports automated, repeatable workflows that streamline the incorporation of new data in a manner that can help to keep a modeled subsurface (e.g., dynamic reservoir) live and current. Migrator functionality of the INTERSECT® simulator can allow reservoir engineers to move from the ECLIPSE® reservoir simulator to the INTERSECT® simulator, with data validation performed by both the migrator and INTERSECT® simulator to help to ensure the quality of a reservoir model. The INTERSECT® simulator can deliver insights through reservoir characterization. As an example, a simulator (e.g., and/or a framework) may be implemented in one or more manners (e.g., workstation, laptop, in-house cluster, service in the cloud, etc.).

Referring again to microemulsions, a simulator may encounter some challenges where a microemulsion exists as a phase, which may come into existence and/or dissipate (e.g., via one or more mechanisms). A simulator that aims to characterize a reservoir, particular dynamic behavior of the reservoir, may experience numerical stability issues, for example, due to abrupt changes on mobility (e.g., relative permeability divided by viscosity) of phases present which can be observed as discontinuities/oscillations of field level quantities such as production rates. Such discontinuities may result from both specifics of the implementation in a simulator as well as the physical nature of a process or processes.

As an example, a method can include executing a simulator in a manner that mitigates the impact of one or more abrupt changes on mobility calculations. Such a method can allow a simulator to accurately model surfactant flooding processes where one or more abrupt changes occur as to mobility (e.g., relative permeability divided by viscosity) of phases.

A method can include refining the calculation of the phase mobilities to mitigate one or more sudden changes associated with the evolution of a physical system from a two phase oil-water state to a three phase oil-water-ME state.

As an example, an appropriate definition of a displacing phase in a multi-phase oil-water-ME system may be provided. In a two-phase oil-water system, the two phases can be mutually displacing (e.g., oil displaces water, water displaces oil). In a three-phase oil-water-ME system, one convention (per the UTCHEM simulator) is to have ME displacing both oil and water. However, such a convention can cause one or more discontinuities in situations if where a change tends to abrupt (per the UTCHEM simulator). As an example, a method can include considering a ME phase as a displacing phase if the ME phase is mobile.

Relative permeabilities can be functions of saturations of phases present in a physical system. In the evolution from a two-phase oil-water system to a three phase oil-water-ME system, the saturations of the oil and water phase saturations can exhibit a substantial jump as the volume of the newly formed ME phase is accommodated. Such a jump can be propagated to the relative permeabilities of the oil and water phases, which can lead to discontinuities in the phase mobilities. A calculation of the relative permeability in this regime will therefore be erroneous (not matching the physical system). As an example, in such a scenario, a simulator can include instructions stored in a computer-readable medium that are executable by one or more processors for calculating physically reasonable values for the oil and water relative permeabilities such that numerical stability can be enhanced. Such an approach may facilitate convergence to a reasonable solution that characterizes a reservoir, particularly as to its dynamic behavior (e.g., for the production of a resource such as oil, etc.).

As an example, a method can include calculating the relative permeability as follows:
a. On emergence of a ME phase, the values of the oil and water relative permeabilities can be held at their values just prior to the appearance of the ME phase (e.g., via storage in a computer-readable medium, etc., as a data structure, etc.); the value of the relative permeability can be labelled k_{rα}^{A} for α=O, W
b. Once the ME phase saturation has exceeded a certain saturation, labelled S_{M}^{A′}, the values of the oil and water relative permeabilities can be calculated by interpolating between the value k_{rα}^{A} for α=O, W and the value predicted by a relative permeability model (e.g., the relative permeability model utilized prior)
c. Once the ME phase saturation has exceeded a second saturation, labeled S_{M}^{B}, the relative permeabilities can be calculated using the relative permeability model (e.g., the relative permeability model utilized prior).

Below, various examples of equipment, frameworks, simulators, etc. are described, which may be utilized to implement one or more techniques for reservoir characterization. Such examples may be utilized, for example, to characterize one or more formations subject to chemical EOR (e.g., surfactant flooding, etc.). As an example, an operation can include surfactant flooding. Such an enhanced oil recovery process can include adding an amount of surfactant(s) to an aqueous fluid injected into a reservoir, for example, in a manner that aims to sweep the reservoir. In such a chemical EOR, the presence of surfactant aims to reduce the interfacial tension (IFT) between the oil and water phases and can, for example, alter wettability of reservoir rock in a manner that can improve oil recovery.

As to permeability for characterizing a reservoir via reservoir simulation (e.g., via a reservoir simulator), data can be in a tabulated form (e.g., discrete data points, etc.) that may represent a function of phase relative permeability versus phase saturation (e.g., or a “curve” of phase relative permeability versus phase saturation). Of such function data, so-called end-points may be defined. For example, consider the following end-points: (i) connate saturation, the saturation below which a phase does not fall; (ii) critical saturation, the highest saturation for which a relative permeability of a phase is zero (e.g., at a saturation value above the critical saturation value, a phase may be deemed to be mobile); and (iii) maximum saturation, the saturation above which a phase does not exceed. As an example, saturation functions may be specified to honor certain conditions between phases, which may arise, for example, due to mass conservation (e.g., mass balance), as phase saturations of multiple fluids that may be constrained to sum to unity (e.g., approximately unity within an error limit or error limits).

As an example, a subsurface environment may be understood via data acquisition and analysis. As an example, seismology may be used to acquire data. In such an example, the data may be subject to interpretation. For example, consider seismic interpretation as a process that involves examining seismic data (e.g., with respect to location and time or depth) to identify one or more types of subsurface structures (e.g., facies, horizons, faults, geobodies, etc.). Seismic data may optionally be interpreted with other data such as, for example, well log data. As an example, a process may include receiving data and generating a model based at least in part on such data.

As an example, a process may include determining one or more seismic attributes. A seismic attribute may be considered, for example, a way to describe, quantify, etc., characteristic content of seismic data. As an example, a quantified characteristic may be computed, measured, etc., from seismic data. As an example, a framework may include processor-executable instructions stored in memory to determine one or more seismic attributes. Seismic attributes may optionally be classified, for example, as volume attributes or surface attributes or one-dimensional attributes.

A seismic interpretation may be performed using displayable information, for example, by rendering information to a display device, a projection device, a printing device, etc. As an example, one or more color schemes (e.g., optionally including black and white or greyscale) may be referenced for displayable information to enhance visual examination of the displayable information. Where the human eye will be used or is used for viewing displayable information, a display scheme may be selected to enhance interpretation.

As an example, seismic interpretation may be performed using seismic to simulation software such as the PETREL® seismic to simulation software framework (Schlumberger Limited, Houston, Tex.), which includes various features to perform attribute analyses (e.g., with respect to a 3D seismic cube, a 2D seismic line, etc.). While the PETREL® seismic to simulation software framework is mentioned, other types of software, frameworks, etc., may be employed. As an example, a model built using a framework may be utilized by a simulator, for example, consider a reservoir simulator such as the ECLIPSE® simulator (Schlumberger Limited, Houston, Tex.), the INTERSECT® simulator (Schlumberger Limited, Houston, Tex.), etc.

As an example, “pay” may be a reservoir or portion of a reservoir that includes economically producible hydrocarbons (e.g., pay sand, pay zone, etc.). The overall interval in which pay sections occur may be referred to as gross pay; where, for example, smaller portions of the gross pay that meet local criteria for pay (e.g., such as minimum porosity, permeability and hydrocarbon saturation) are referred to as net pay. As an example, a reservoir simulator may assess a geologic environment that includes at least a portion of a reservoir (e.g., or reservoirs) as to its physical properties that may be used to estimate pay. In such an example, parameters as to physical properties such as porosity, permeability and saturation may be included within equations that can model a geologic environment. As an example, such properties may be initialized prior to performing a simulation. In such an example, values for the properties may affect simulation results, convergence of a simulation solution, etc. As an example, a method can include adjusting values prior to performing a simulation, which may, in turn, reduce computation time, enhance convergence rate, allow for output of a converged solution, etc.

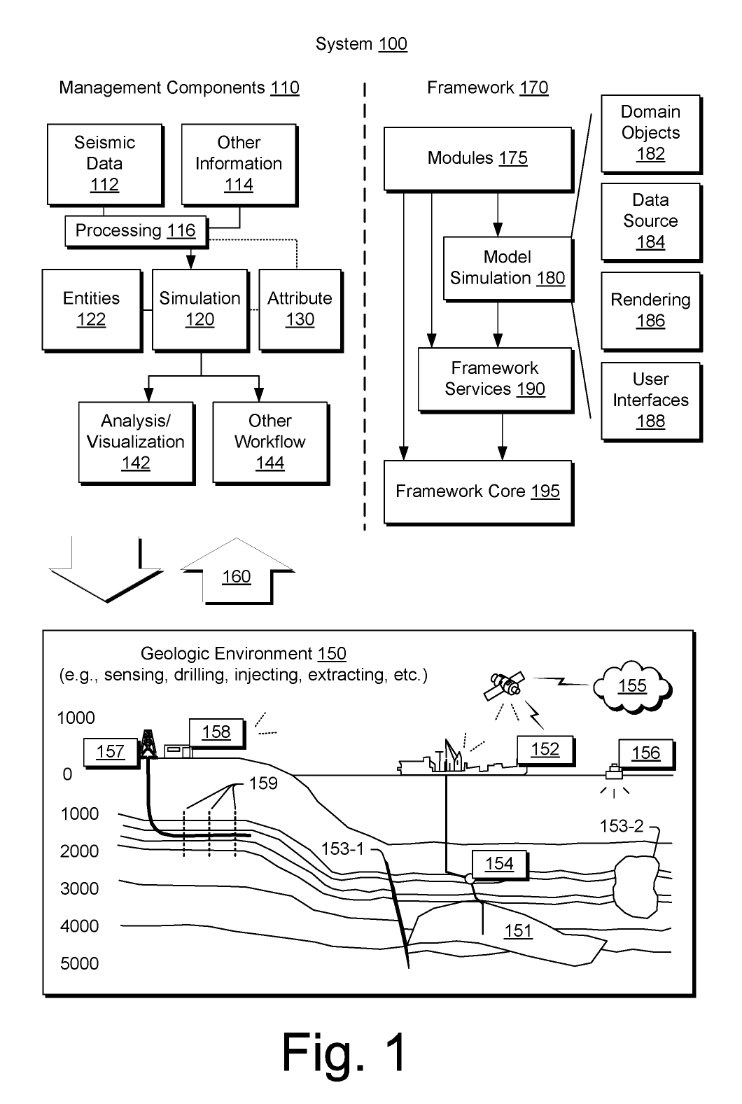

FIG. 1 shows an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. An example of an object-based framework is the MICROSOFT® .NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE® reservoir simulator, the INTERSECT® reservoir simulator, etc. As an example, a simulation component, a simulator, etc. may optionally include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a framework such as the PETREL® seismic to simulation software framework. The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a framework environment such as the OCEAN® framework environment (Schlumberger Limited, Houston, Tex.) allows for integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include one or more features of the OCEAN® framework where the model simulation layer 180 may include one or more features of the PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh. As an example, a mesh may be a grid. Such constructs (e.g., meshes or grids) may be defined by nodes, cells, intervals, segments, etc. As mentioned, a so-called meshless approach may be implemented, for example, based on points such as in a point cloud, etc.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, sets of instructions, etc.).

As an example, a framework may be implemented within or in a manner operatively coupled to the DELFI® cognitive E&P environment (Schlumberger Limited, Houston, Tex.), which is a secure, cognitive, cloud-based collaborative environment that integrates data and workflows with digital technologies, such as artificial intelligence and machine learning. As an example, the PETREL® framework may be utilized in conjunction with the DELFI® environment. As an example, one or more methods may be implemented at least in part via a framework (e.g., a computational framework) and/or an environment (e.g., a computational environment).

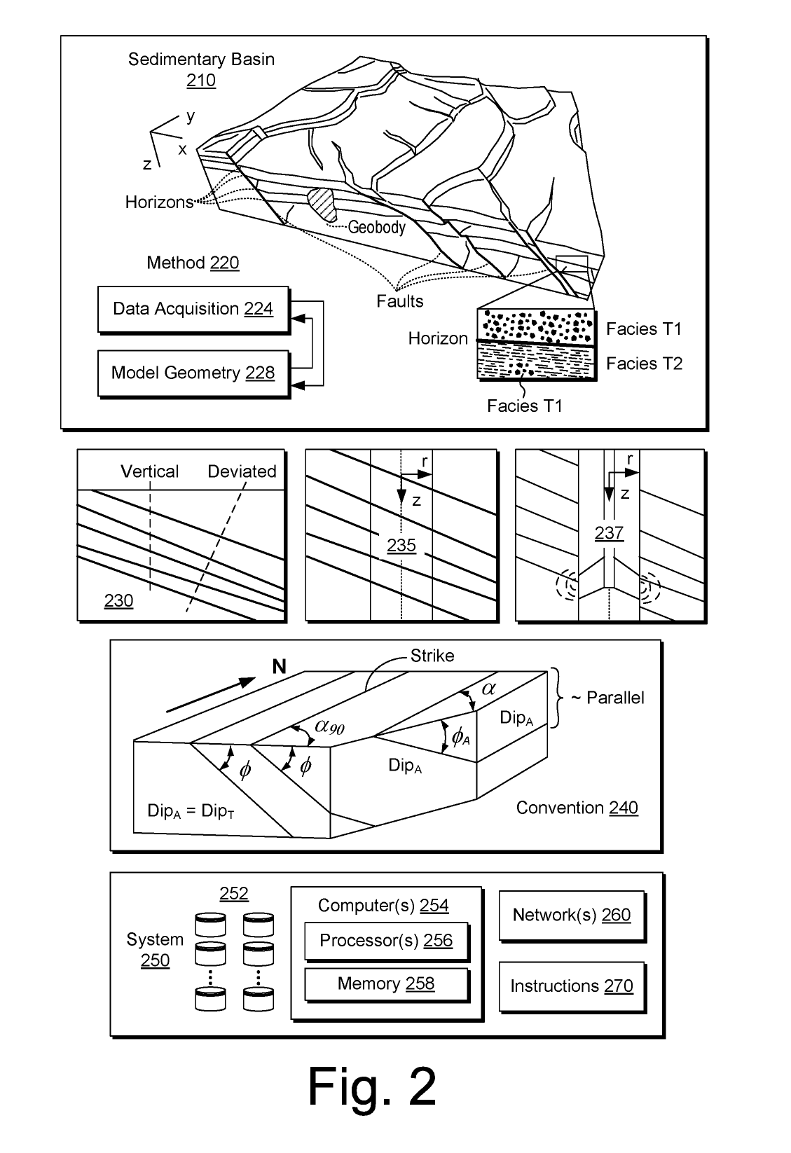

FIG. 2 shows an example of a sedimentary basin 210 (e.g., a geologic environment), an example of a method 220 for model building (e.g., for a simulator, etc.), an example of a formation 230, an example of a borehole 235 in a formation, an example of a convention 240 and an example of a system 250.

As an example, reservoir simulation, petroleum systems modeling, etc. may be applied to characterize various types of subsurface environments, including environments such as those of FIG. 1.

In FIG. 2, the sedimentary basin 210, which is a geologic environment, includes horizons, faults, one or more geobodies and facies formed over some period of geologic time. These features are distributed in two or three dimensions in space, for example, with respect to a Cartesian coordinate system (e.g., x, y and z) or other coordinate system (e.g., cylindrical, spherical, etc.). As shown, the model building method 220 includes a data acquisition block 224 and a model geometry block 228. Some data may be involved in building an initial model and, thereafter, the model may optionally be updated in response to model output, changes in time, physical phenomena, additional data, etc. As an example, data for modeling may include one or more of the following: depth or thickness maps and fault geometries and timing from seismic, remote-sensing, electromagnetic, gravity, outcrop and well log data. Furthermore, data may include depth and thickness maps stemming from facies variations (e.g., due to seismic unconformities) assumed to following geological events (“iso” times) and data may include lateral facies variations (e.g., due to lateral variation in sedimentation characteristics).

To proceed to modeling of geological processes, data may be provided, for example, data such as geochemical data (e.g., temperature, kerogen type, organic richness, etc.), timing data (e.g., from paleontology, radiometric dating, magnetic reversals, rock and fluid properties, etc.) and boundary condition data (e.g., heat-flow history, surface temperature, paleowater depth, etc.).

In basin and petroleum systems modeling, quantities such as temperature, pressure and porosity distributions within the sediments may be modeled, for example, by solving partial differential equations (PDEs) using one or more numerical techniques. Modeling may also model geometry with respect to time, for example, to account for changes stemming from geological events (e.g., deposition of material, erosion of material, shifting of material, etc.).

A modeling framework such as the PETROMOD® framework (Schlumberger Limited, Houston, Tex.) can include features for input of various types of information (e.g., seismic, well, geological, etc.) to model evolution of a sedimentary basin. The PETROMOD® framework provides for petroleum systems modeling via input of various data such as seismic data, well data and other geological data, for example, to model evolution of a sedimentary basin. The PETROMOD® framework may predict if, and how, a reservoir has been charged with hydrocarbons, including, for example, the source and timing of hydrocarbon generation, migration routes, quantities, pore pressure and hydrocarbon type in the subsurface or at surface conditions. In combination with a framework such as the PETREL® framework, workflows may be constructed to provide basin-to-prospect scale exploration solutions. Data exchange between frameworks can facilitate construction of models, analysis of data (e.g., PETROMOD® framework data analyzed using PETREL® framework capabilities), and coupling of workflows.

As shown in FIG. 2, the formation 230 includes a horizontal surface and various subsurface layers. As an example, a borehole may be vertical. As another example, a borehole may be deviated. In the example of FIG. 2, the borehole 235 may be considered a vertical borehole, for example, where the z-axis extends downwardly normal to the horizontal surface of the formation 230. As an example, a tool 237 may be positioned in a borehole, for example, to acquire information. As mentioned, a borehole tool may be configured to acquire electrical borehole images. As an example, the fullbore Formation Microlmager (FMI) tool (Schlumberger Limited, Houston, Tex.) can acquire borehole image data. A data acquisition sequence for such a tool can include running the tool into a borehole with acquisition pads closed, opening and pressing the pads against a wall of the borehole, delivering electrical current into the material defining the borehole while translating the tool in the borehole, and sensing current remotely, which is altered by interactions with the material.

As an example, a borehole may be vertical, deviate and/or horizontal. As an example, a tool may be positioned to acquire information in a horizontal portion of a borehole. Analysis of such information may reveal vugs, dissolution planes (e.g., dissolution along bedding planes), stress-related features, dip events, etc. As an example, a tool may acquire information that may help to characterize a fractured reservoir, optionally where fractures may be natural and/or artificial (e.g., hydraulic fractures). Such information may assist with completions, stimulation treatment, etc. As an example, information acquired by a tool may be analyzed using a framework such as the TECHLOG® framework (Schlumberger Limited, Houston, Tex.).

As to the convention 240 for dip, as shown, the three dimensional orientation of a plane can be defined by its dip and strike. Dip is the angle of slope of a plane from a horizontal plane (e.g., an imaginary plane) measured in a vertical plane in a specific direction. Dip may be defined by magnitude (e.g., also known as angle or amount) and azimuth (e.g., also known as direction). As shown in the convention 240 of FIG. 2, various angles ϕ indicate angle of slope downwards, for example, from an imaginary horizontal plane (e.g., flat upper surface); whereas, dip refers to the direction towards which a dipping plane slopes (e.g., which may be given with respect to degrees, compass directions, etc.). Another feature shown in the convention of FIG. 2 is strike, which is the orientation of the line created by the intersection of a dipping plane and a horizontal plane (e.g., consider the flat upper surface as being an imaginary horizontal plane).

Some additional terms related to dip and strike may apply to an analysis, for example, depending on circumstances, orientation of collected data, etc. One term is “true dip” (see, e.g., Dip_{T} in the convention 240 of FIG. 2). True dip is the dip of a plane measured directly perpendicular to strike (see, e.g., line directed northwardly and labeled “strike” and angle α₉₀) and also the maximum possible value of dip magnitude. Another term is “apparent dip” (see, e.g., Dip_{A} in the convention 240 of FIG. 2). Apparent dip may be the dip of a plane as measured in any other direction except in the direction of true dip (see, e.g., ϕ_{A} as Dip_{A} for angle α); however, it is possible that the apparent dip is equal to the true dip (see, e.g., ϕ as Dip_{A}=Dip_{T} for angle α₉₀ with respect to the strike). In other words, where the term apparent dip is used (e.g., in a method, analysis, algorithm, etc.), for a particular dipping plane, a value for “apparent dip” may be equivalent to the true dip of that particular dipping plane.

As shown in the convention 240 of FIG. 2, the dip of a plane as seen in a cross-section perpendicular to the strike is true dip (see, e.g., the surface with ϕ as Dip_{A}=Dip_{T} for angle α₉₀ with respect to the strike). As indicated, dip observed in a cross-section in any other direction is apparent dip (see, e.g., surfaces labeled Dip_{A}). Further, as shown in the convention 240 of FIG. 2, apparent dip may be approximately 0 degrees (e.g., parallel to a horizontal surface where an edge of a cutting plane runs along a strike direction).

In terms of observing dip in wellbores, true dip is observed in wells drilled vertically. In wells drilled in any other orientation (or deviation), the dips observed are apparent dips (e.g., which are referred to by some as relative dips). In order to determine true dip values for planes observed in such boreholes, as an example, a vector computation (e.g., based on the borehole deviation) may be applied to one or more apparent dip values.

As mentioned, another term that finds use in sedimentological interpretations from borehole images is “relative dip” (e.g., Dip_{R}). A value of true dip measured from borehole images in rocks deposited in very calm environments may be subtracted (e.g., using vector-subtraction) from dips in a sand body. In such an example, the resulting dips are called relative dips and may find use in interpreting sand body orientation.

A convention such as the convention 240 may be used with respect to an analysis, an interpretation, an attribute, etc. (see, e.g., various blocks of the system 100 of FIG. 1). As an example, various types of features may be described, in part, by dip (e.g., sedimentary bedding, faults and fractures, cuestas, igneous dikes and sills, metamorphic foliation, etc.). As an example, dip may change spatially as a layer approaches a geobody. For example, consider a salt body that may rise due to various forces (e.g., buoyancy, etc.). In such an example, dip may trend upward as a salt body moves upward.

Seismic interpretation may aim to identify and/or classify one or more subsurface boundaries based at least in part on one or more dip parameters (e.g., angle or magnitude, azimuth, etc.). As an example, various types of features (e.g., sedimentary bedding, faults and fractures, cuestas, igneous dikes and sills, metamorphic foliation, etc.) may be described at least in part by angle, at least in part by azimuth, etc.

As an example, equations may be provided for petroleum expulsion and migration, which may be modeled and simulated, for example, with respect to a period of time. Petroleum migration from a source material (e.g., primary migration or expulsion) may include use of a saturation model where migration-saturation values control expulsion. Determinations as to secondary migration of petroleum (e.g., oil or gas), may include using hydrodynamic potential of fluid and accounting for driving forces that promote fluid flow. Such forces can include buoyancy gradient, pore pressure gradient, and capillary pressure gradient.

As shown in FIG. 2, the system 250 includes one or more information storage devices 252, one or more computers 254, one or more networks 260 and one or more sets of instructions 270. As to the one or more computers 254, each computer may include one or more processors (e.g., or processing cores) 256 and memory 258 for storing instructions (e.g., one or more sets of instructions 270), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252.

As an example, the one or more sets of instructions 270 may include instructions (e.g., stored in memory) executable by one or more processors to instruct the system 250 to perform various actions. As an example, the system 250 may be configured such that the one or more sets of instructions 270 provide for establishing the framework 170 of FIG. 1 or a portion thereof. As an example, one or more methods, techniques, etc. may be performed using one or more sets of instructions, which may be, for example, one or more of the one or more sets of instructions 270 of FIG. 2.

As an example, “pay” may be a reservoir or portion of a reservoir that includes economically producible hydrocarbons (e.g., pay sand, pay zone, etc.). The overall interval in which pay sections occur may be referred to as the gross pay; where, for example, smaller portions of the gross pay that meet local criteria for pay (e.g., such as minimum porosity, permeability and hydrocarbon saturation) are net pay. Thus, a workflow may include assessing a geologic environment that includes at least a portion of a reservoir (e.g., or reservoirs) as to its physical properties that may be used to estimate pay. For example, an assessment may include acquiring data, estimating values, etc. and running a simulation using a reservoir simulator. In such an example, parameters as to physical properties such as porosity, permeability and saturation may be included within equations that can model a geologic environment.

As an example, porosity may be defined as the percentage of pore volume or void space, or that volume within rock that can include fluid(s). Porosity may be a relic of deposition (e.g., primary porosity, such as space between grains that were not compacted together completely) or it may develop through alteration of the rock (e.g., secondary porosity, such as when feldspar grains or fossils are dissolved from sandstones). Porosity may be generated by development of fractures (e.g., consider fracture porosity). Effective porosity may be defined as the interconnected pore volume in rock that can contribute to fluid flow in a reservoir (e.g., excluding isolated pores). Total porosity may be defined as the total void space in rock whether or not it can contribute to fluid flow (e.g., consider effective porosity being less than total porosity). As an example, a shale gas reservoir may tend to have relatively high porosity, however, alignment of platy grains such as clays can make for low permeability.

As an example, permeability may be defined as an ability, or measurement of rock ability, to transmit fluids, which may be measured in units such as darcies, millidarcies, etc. Formations that transmit fluids readily (e.g., sandstones) may be characterized as being “permeable” and may tend to include connected pores; whereas, “impermeable” formations (e.g., shales and siltstones) may tend to be finer grained or of a mixed grain size, with smaller, fewer, or less interconnected pores.

Absolute permeability is the measurement of the permeability conducted when a single fluid, or phase, is present in a matrix (e.g., in rock). Effective permeability is the ability to preferentially flow or transmit a particular fluid through a rock when other immiscible fluids are present in the reservoir (e.g., effective permeability of gas in a gas-water reservoir). The relative saturations of fluids as well as the nature of a reservoir can affect effective permeability. As an example, saturation may be defined for a water, oil and gas as the relative amount of the water, the oil and the gas in pores of rock, for example, as a percentage of volume.

Relative permeability may be defined as the ratio of effective permeability of a particular fluid at a particular saturation to absolute permeability of that fluid at total saturation. As an example, if a single fluid is present in rock, its relative permeability may be 1 (unity). Calculation of relative permeability can allow for comparison of different abilities of fluids to flow in the presence of each other, for example, as the presence of more than one fluid may tend to inhibit flow.

As an example, a method may include creating a simulation case, for example, using a framework (e.g., the OCEAN® framework). In such an example, a workflow may include initiating a simulation case, optionally using a tool such as a “wizard”. As an example, a workflow can include defining arguments. For example, consider arguments that may be associated with a grid model of a geologic environment. In such an example, a grid model may be a pillar grid model or other type of grid model. Arguments associated with a grid model may include physical properties of rock such as, for example, porosity and permeability and may include functions that can define physical phenomena such as, for example, a saturation function, a rock compaction function, a black oil fluid function, etc.

As an example, a workflow may include accessing a reservoir simulator such as, for example, an ECLIPSE® reservoir simulator, an INTERSECT® reservoir simulator, etc. As an example, a workflow can include getting a grid from a grid porosity property and, for example, setting a case grid property argument (e.g., .Grid.Matrix.Porosity) to an input porosity property (e.g., as a “GridItem<Property>”). As an example, a workflow can include setting grid property arguments (e.g., “Grid.Matrix.Permeability” for indexes I, J and K of a grid) to appropriate input permeability properties (e.g., as a “GridItem<Property>”). As an example, a workflow can include setting one or more case function arguments. For example, consider a saturation function being set to an input function, a rock compaction function being set to an input function, a black oil function being set to an input function, etc.

As an example, a workflow may include a case argument for a simulation case such as an initialization argument (e.g., consider “InitializeByEquilibration”).

As an example, a workflow can include receiving properties and functions. For example, consider accessing data for a project created with a framework such as the PETREL® framework. In such an example, data may be received for purposes of performing a simulation such as a reservoir simulation. For example, consider a Gullfaks project (e.g., for at least a portion of the Gullfaks field, an oil and gas field in the Norwegian sector of the North Sea) where properties such as permeability and porosity may be loaded, a sand saturation function (e.g., as a type of rock physics function) may be loaded, a consolidated sandstone rock compaction function may be loaded (e.g., as a type of rock physics function), where “light oil and gas” may be loaded as a black oil fluid input, etc. Given various properties and functions, a simulation may be run that may provide simulation results.

As an example, a grid may include grid cells where properties are defined with respect to a position or positions of a grid cell. For example, a property may be defined as being at a centroid of a grid cell. As an example, consider cell properties such as porosity (e.g., a PORO parameter), permeability in an x-direction (e.g., a PERMX parameter), permeability in a y-direction (e.g., a PERMY parameter), permeability in a z-direction (e.g., a PERMZ parameter) and net-to-gross ratio (e.g., NTG) being defined as averages for a cell at a center of a cell. In such an example, the directions x, y and z may correspond to directions of indexes (e.g., I, J and K) of a grid that may model a geologic environment.

As an example, a reservoir simulator may take as input values that may be predetermined. For example, to approximate multiphase flow effects through porous media, one or more tabulated saturation functions values may be used that characterize relative permeability of a phase given one or more saturations of one or more other phases. As an example, tabulated functions may be available on a facies dependent basis where values are available for individual facies. As an example, where a cell of a model (e.g., a grid cell) is associated with a particular facies, that cell may be assigned a value from a table (e.g., or other form for a predetermined value). In such an example, multiple cells may be assigned a common value. For a corresponding geologic environment, common values assigned to cells that model a region of the geologic environment may be an approximation of the geologic environment. In other words, values that differ for one or more of the cells may more accurately represent the region of the geologic environment.

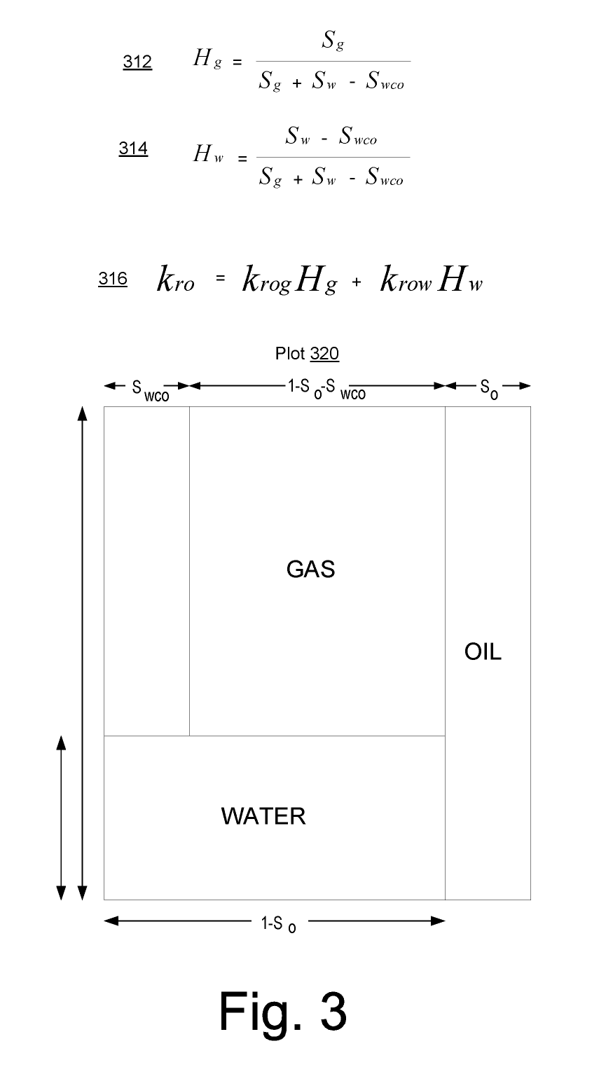

FIG. 3 shows an example of a model for fraction of mobile gas 312 and a model for fraction of mobile water 314, an example of a multi-phase oil relative permeability mixing rule 316 and a plot 320 that illustrates portions of water, gas and oil phases with respect to saturations. As illustrated in FIG. 3, oil relative permeability depends on saturations.

As an example, in the context of a geologic environment that includes a reservoir to be developed or under development, a reservoir simulator may be used to assess the environment, optionally before drilling of one or more wells or other operations (e.g., fracturing, etc.). In such an example, a reservoir simulator may be implemented to advance in time (e.g., via time increments, etc.) given one or more wells where, for example, an individual well may be assigned to be a sink or a source. As an example, a well may be an injection well or a production well. Information such as that of the plot 320 of FIG. 3 may facilitate development, for example, to understand better where mobile oil may exist within a reservoir, to understand better where injection or other recovery techniques may be implemented to produce oil, etc.

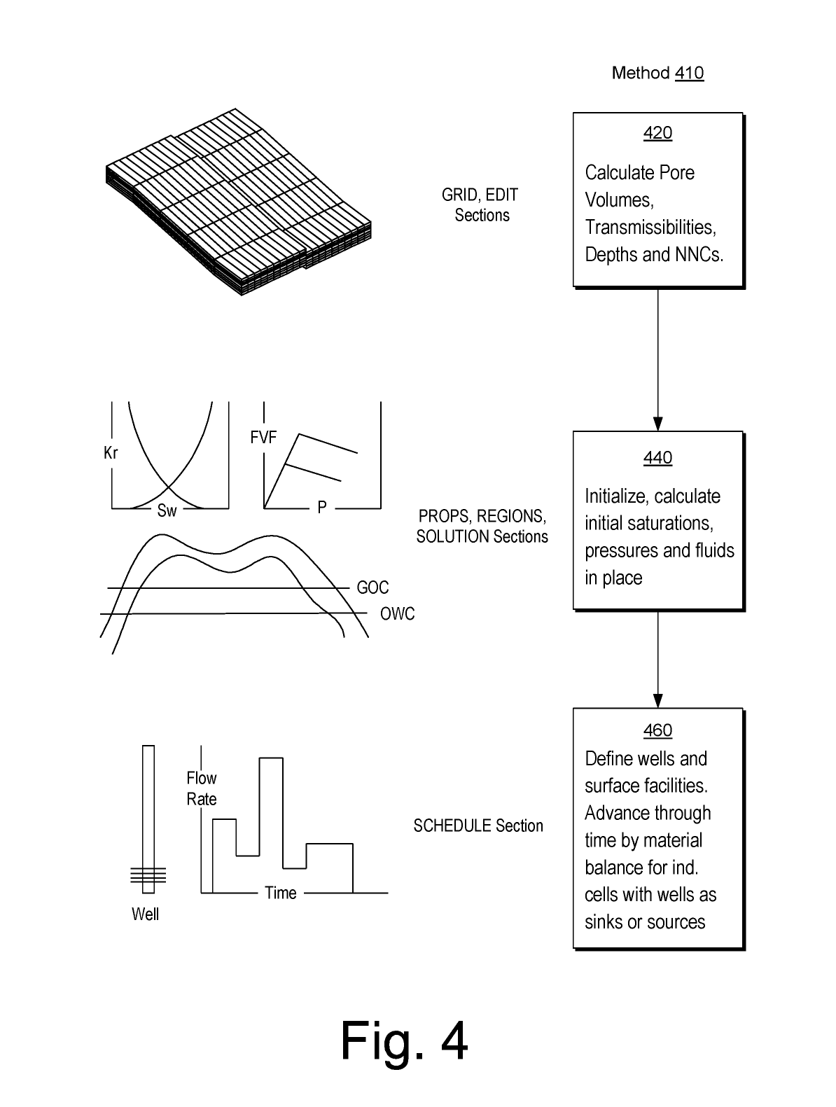

FIG. 4 shows an example of a method 410 that includes a calculation block 420 for calculating pore volumes, transmissibilities, depths and NNCs, an initialization and calculation block 440 for initializing and calculating initial saturations, pressure and fluids in place, and a definition and time progression block 460 for defining one or more wells and surface facilities and advancing through time, for example, via material balances for individual cells (e.g., with the one or more wells as individual sinks and/or sources).

As to the initialization and calculation block 440, for an initial time (e.g., to), saturation distribution within a grid model of a geologic environment and pressure distribution within the grid model of the geologic environment may be set to represent an equilibrium state (e.g., a static state or “no-flow” state), for example, with respect to gravity. As an example, to approximate the equilibrium state, calculations can be performed. As an example, such calculations may be performed by one or more sets of instructions. For example, one or more of a seismic-to-simulation framework, a reservoir simulator, a specialized sets of instructions, etc. may be implemented to perform one or more calculations that may aim to approximate or to facilitate approximation of an equilibrium state. As an example, a reservoir simulator may include a set of instructions for initialization using data to compute capillary and fluid gradients, and hence fluid saturation densities in individual cells of a grid model that represents a geologic environment.

Initialization aims to define fluid saturations in individual cells such that a “system” being modeled is in an equilibrium state (e.g., where no external forces are applied, no fluid flow is to take place in a reservoir, a condition that may not be obeyed in practice). As an example, consider oil-water contact and assume no transition zone, for example, where water saturation is unity below an oil-water contact and at connate water saturation above the contact. In such an example, grid cells that include oil-water contact may pose some challenges. A cell (e.g., or grid cell) may represent a point or points in space for purposes of simulating a geologic environment. Where an individual cell represents a volume and where that individual cell includes, for example, a center point for definition of properties, within the volume of that individual cell, the properties may be constant (e.g., without variation within the volume). In such an example, that individual cell includes one value per property, for example, one value for water saturation. As an example, an initialization process can include selecting a value for individual properties of individual cells.

As an example, saturation distribution may be generated based on one or more types of information. For example, saturation distribution may be generated from seismic information and saturation versus depth measurements in one or more boreholes (e.g., test wells, wells, etc.). As an example, reproduction of such an initial saturation field via a simulation model may be inaccurate and such an initial saturation field may not represent an equilibrium state, for example, as a simulator model approximates real physical phenomena.

As an example, an initialization of water saturation may be performed using information as to oil-water contact. For example, for a cell that is below oil-water contact, a water saturation value for that cell may be set to unity (i.e., as water is the more dense phase, it is below the oil-water contact); and for a cell that is above oil-water contact, a water saturation value for that cell may be set to null (i.e., as oil is the lighter phase, it exists above water and hence is assumed to be free of water). Thus, in such an example, where at least some information as to spatially distributed depths of oil-water contact may be known, an initialized grid cell model may include cells with values of unity and cells with values of zero for water saturation.

As mentioned, an initialized grid cell model may not be in an equilibrium state. Thus, sets of instructions may be executed using a computing device, a computing system, etc. that acts to adjust an initialized grid cell model to approximate an equilibrium state. Given a certain saturation field for a grid cell model, a technique may adjust relative permeability end points (e.g., critical saturations) such that relevant fluids are just barely immobile at their calculated or otherwise defined initial saturations. As a result, the grid cell model, as initialized, may represent a quiescent state in the sense that no flow will occur if a simulation is started without application of some type of “force” (e.g., injection, production, etc.).

As mentioned, a reservoir simulator may advance in time. As an example, a numeric solver may be implemented that can generate a solution for individual time increments (e.g., points in time). As an example, a solver may implement an implicit solution scheme and/or an explicit solution scheme, noting that an implicit solution scheme may allow for larger time increments than an explicit scheme. Times at which a solution is desired may be set forth in a “schedule”. For example, a schedule may include smaller time increments for an earlier period of time followed by larger time increments.

A solver may implement one or more techniques to help assure stability, convergence, accuracy, etc. For example, when advancing a solution in time, a solver may implement sub-increments of time, however, an increase in the number of increments can increase computation time. As an example, an adjustable increment size may be used, for example, based on information of one or more previous increments.

As an example, a numeric solver may implement one or more of a finite difference approach, a finite element approach, a finite volume approach, etc. As an example, the ECLIPSE® reservoir simulator can implement central differences for spatial approximation and forward differences in time. As an example, a matrix that represents grid cells and associated equations may be sparse, diagonally banded and blocked as well as include off-diagonal entries.

As an example, a solver may implement an implicit pressure, explicit saturation (IMPES) scheme. Such a scheme may be considered to be an intermediate form of explicit and implicit techniques. In an IMPES scheme, saturations are updated explicitly while pressure is solved implicitly.

As to conservation of mass, saturation values (e.g., for water, gas and oil) in individual cells of a grid cell model may be specified to sum to unity, which may be considered a control criterion for mass conservation. In such an example, where the sum of saturations is not sufficiently close to unity, a process may be iterated until convergence is deemed satisfactory (e.g., according to one or more convergence criteria). As governing equations tend to be non-linear (e.g., compositional, black oil, etc.), a Newton-Raphson type of technique may be implemented, which includes determining derivatives, iterations, etc. For example, a solution may be found by iterating according to the Newton-Raphson scheme where such iterations may be referred to as non-linear iterations, Newton iterations or outer iterations. Where one or more error criteria are fulfilled, the solution procedure has converged, and a converged solution has been found. Thus, within a Newton iteration, a linear problem is solved by performing a number of linear iterations, which may be referred to as inner iterations.

As an example, a solution scheme may be represented by the following pseudo-algorithm:

```
// Pseudo-algorithm for Newton-Raphson for systems
initialize(v);
do {
      //Non-linear iterations
      formulate_non_linear_system(v);
      make_total_differential(v);
      do {
          // Linear iterations:
          update_linear_system_variables(v);
      }
      while((linear_system_has_not_converged(v));
      update_non_linear_system_after_linear_convergence(v);
}
while((non_linear_system_has_not_converged(v))
```

As an example, a solver may perform a number of inner iterations (e.g., linear) and a number of outer iterations (e.g., non-linear). As an example, a number of inner iterations may be of the order of about 10 to about 20 within an outer iteration while a number of outer iterations may be about ten or less for an individual time increment.

As an example, a method can include adjusting values before performing an iteration, which may be associated with a time increment. As an example, a method can include a reception block for receiving values, an adjustment block for optimizing a quadratic function subject to linear constraints for adjusting at least a portion of the values to provide adjusted values and a simulation block to perform a simulation using at least the portion of the adjusted values.

As mentioned, fluid saturation values can indicate how fluids may be distributed spatially in a grid model of a reservoir. For example, a simulation may be run that computes values for fluid saturation parameters (e.g., at least some of which are “unknown” parameters) as well as values for one or more other parameters (e.g., pressure, etc.).

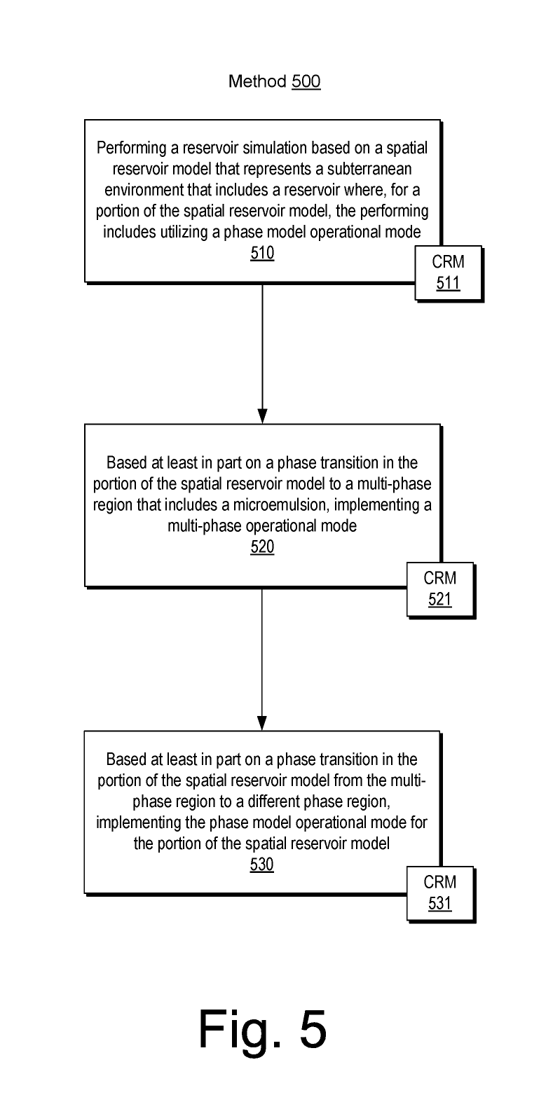

FIG. 5 shows an example of a method 500 that includes a performance block 510 for performing a reservoir simulation based on a spatial reservoir model that represents a subterranean environment that includes a reservoir where, for a portion of the spatial reservoir model, the performing includes utilizing a phase model operational mode; an implementation block 520 for, based at least in part on a phase transition in the portion of the spatial reservoir model to a multi-phase region that includes a microemulsion, implementing a multi-phase operational mode; and an implementation block 530 for, based at least in part on a phase transition in the portion of the spatial reservoir model from the multi-phase region to a different phase region, implementing the phase model operational mode for the portion of the spatial reservoir model.

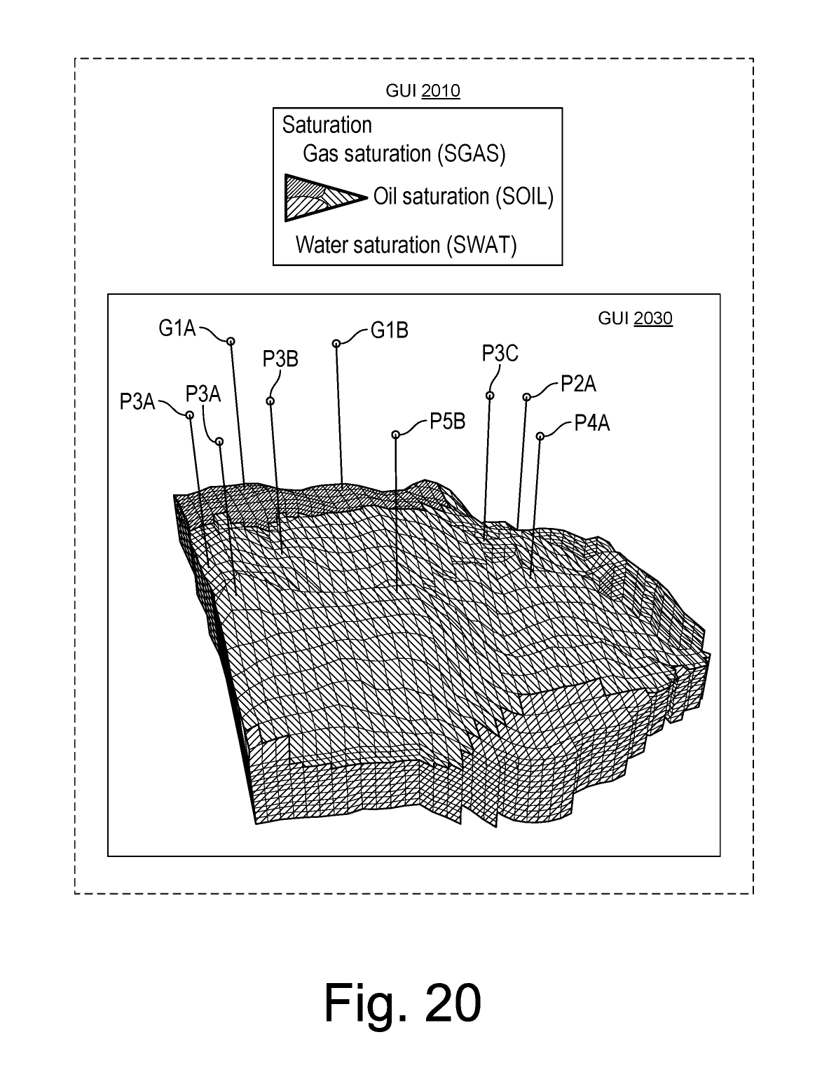

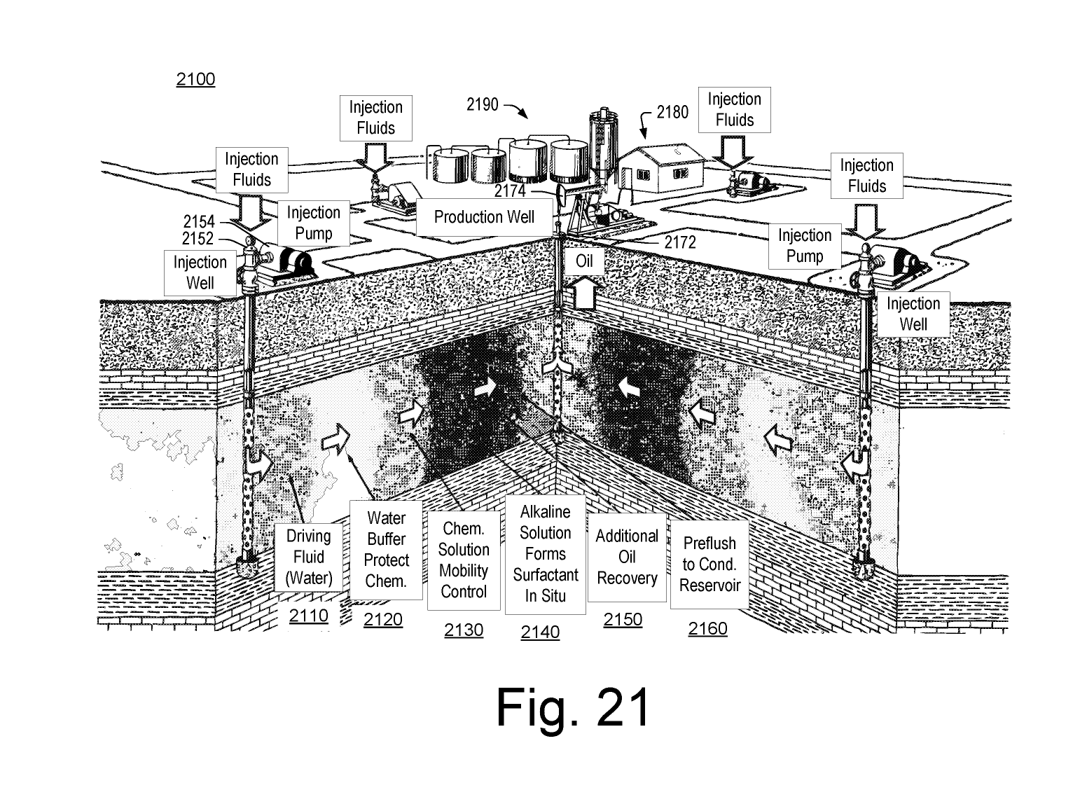

In the example of FIG. 5, the method 500 can control a reservoir simulator such that one or more types of operational modes are implemented based at least in part on underlying physics as to fluids. Such control can be utilized to generate simulation results that can be utilized for controlling one or more pieces of field equipment for performing one or more EOR operations (see, e.g., the system 2100 of FIG. 21). As an example, results of a reservoir simulator can be utilized to generate and render a graphical user interface (GUI) to a display where results are distributed spatially, for example, as in cells of a model of the reservoir being simulated by the reservoir simulator. As an example, an operator and/or a controller may utilized spatially distributed results that correspond to a time or time to issue one or more signals (e.g., commands, etc.) to one or more pieces of field equipment (see, e.g., the GUIs 2010 and 2030 of FIG. 20 and the system 2100 of FIG. 21).

The method 500 is shown in FIG. 5 in association with various computer-readable media (CRM) blocks 511, 521 and 531. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 500. As an example, a computer-readable medium (CRM) may be a computer-readable storage medium that is non-transitory and that is not a carrier wave. As an example, one or more of the block 511, 521 and 531 may be in the form processor-executable instructions, for example, consider the one or more sets of instructions 270 of the system 250 of FIG. 2 (see also the system 2100 of FIG. 21 and the computerized control equipment 2180).

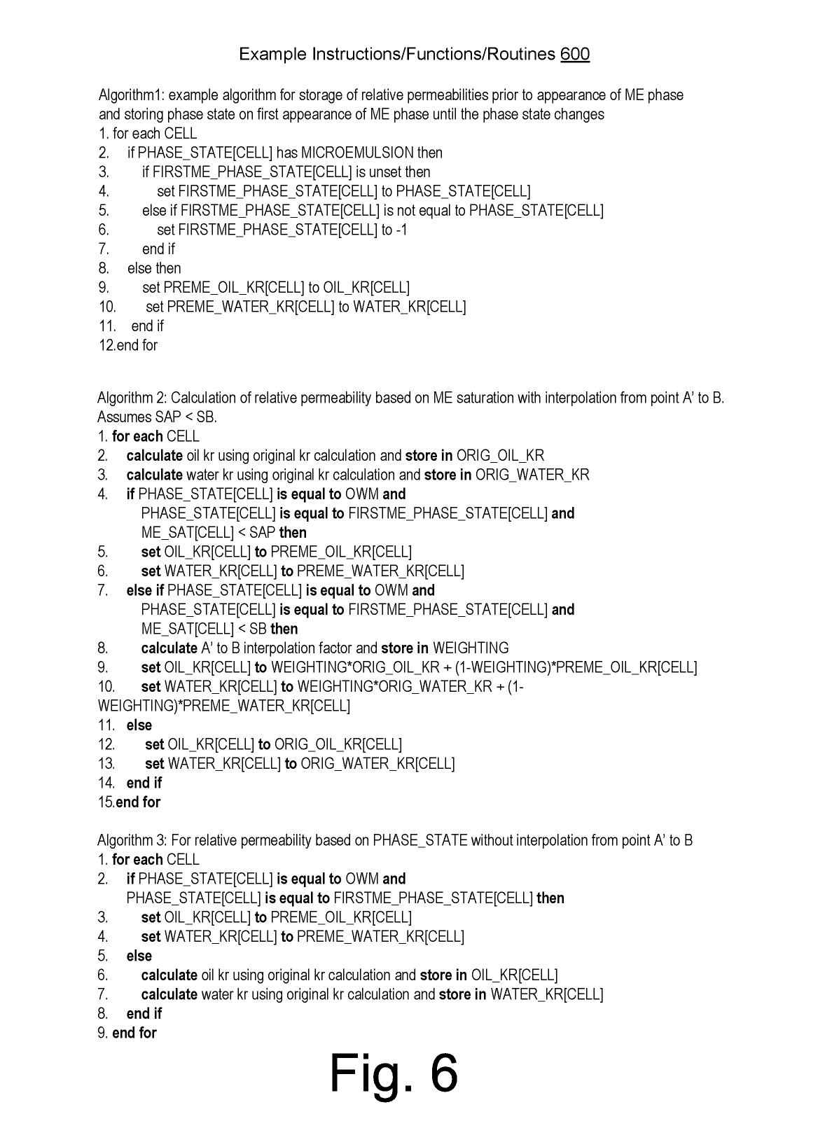

FIG. 6 shows examples of instructions, functions, routines, etc. 600 that may be implemented per the implementation block 520 of the method 500. Such an approach can improve operation of a reservoir simulator. For example, such an approach can enhance results as to accuracy, particularly as to convergence as to a solution that more closes represents physics that can occur in a reservoir (e.g., consider physics associated with chemical EOR such as, for example, surfactant flooding).

In FIG. 6, algorithm 1 is an example algorithm for storage of relative permeabilities prior to appearance of ME phase and storing phase state on first appearance of ME phase until the phase state changes, such storing can be to memory of a system. In FIG. 6, algorithm 2 is an example algorithm for calculation of relative permeability based on ME saturation with interpolation from point A′ to B, where the calculation is performed by one or more processors of a system. In FIG. 6, algorithm 3 is an example algorithm for relative permeability based on PHASE_STATE without interpolation from point A′ to B. As an example, a simulator can include memory that includes processor-executable instructions that can be executed to perform one or more of the example algorithms 1, 2 and 3 in FIG. 6.

As an example, a method can utilize a phase model operational mode and/or utilize a multi-phase operational mode. A phase model operational mode can be, for example, based at least in part on a phase model, which may be represented at least in part via a phase diagram that includes different regions. As an example, a phase model can be a numerical model. Various examples of parameters, etc., are explained herein where such parameter may have numerical values. Various examples of equations are explained herein where such equations can include one or more parameters, which can have one or more numerical values. As an example, a phase model can include one or more equations that include one or more parameters. As an example, a phase model can include, for example, one or more equations that provide for relationships between different components as may be represented by a phase diagram. As an example, a phase model can be a surfactant model, where mobility of one or more components in one or more phases may be taken into account (e.g., according to physics, etc.). As mentioned, mobility can be defined with respect to relative permeability and viscosity, for example, relative permeability divided by viscosity. As an example, a phase model can depend at least in part on relative permeability. As an example, a phase model can be or can include a relative permeability model. As an example, a multi-phase operational mode (e.g., a microemulsion operational mode) can be or include a relative permeability model that differs at least in part from a relative permeability model of a phase model operational mode. As an example, a multi-phase operational mode (e.g., a microemulsion operational mode) can include one or more of a constant relative permeability time period and an interpolation time period.

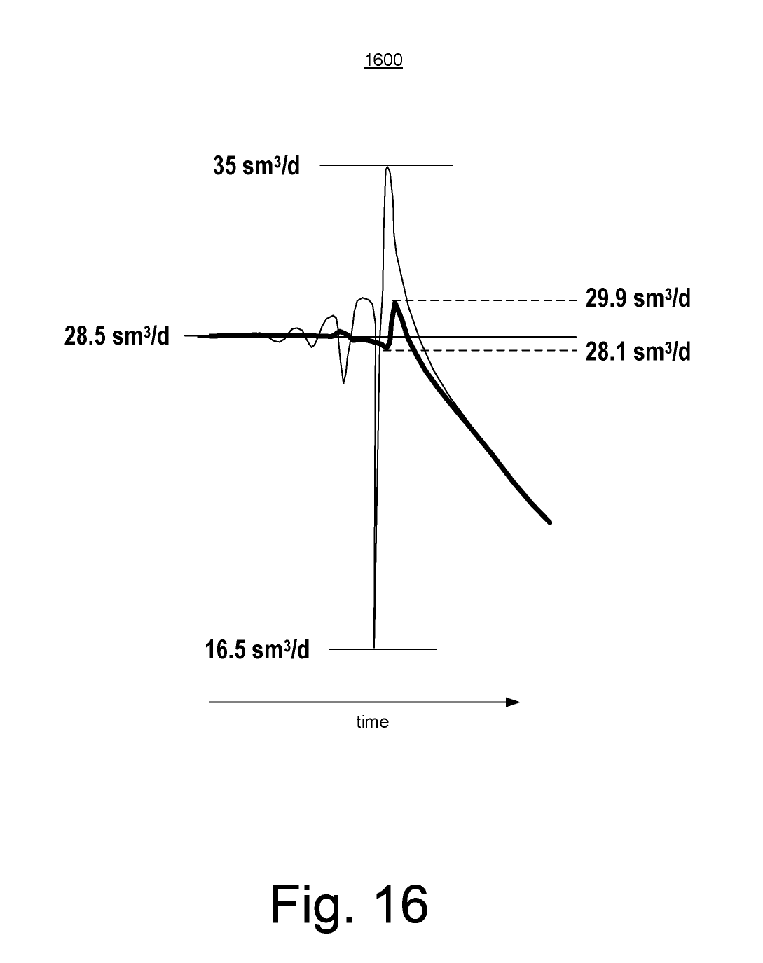

FIG. 16 shows an example of a plot 1600 that includes data for a reservoir simulation that does not implement a multi-phase operational mode and data for a reservoir simulation that implements a multi-phase operational mode. As shown, the multi-phase operational mode can improve reservoir simulation (e.g., simulation results) with respect to physical phenomena that occur in a reservoir. In particular, for various times that correspond to physical phenomena in a reservoir, the multi-phase operational mode can improve a reservoir simulator and hence reservoir simulation by reducing error. In the example of FIG. 16, the error reduced is shown with respect to calculated oil production rate in standard cubic meters per day.

A surfactant model for utilization by a simulator can be based on the symmetric bi-nodal curve model. As an example, formation of a ME phase can be determined by the critical micelle concentration (CMC). In such an example, once the surfactant concentration exceeds this value, the ME phase forms and the IFT between the phases is reduced to an ultra-low value. Physically, the CMC can be thought of as the concentration above which micelles spontaneously form.

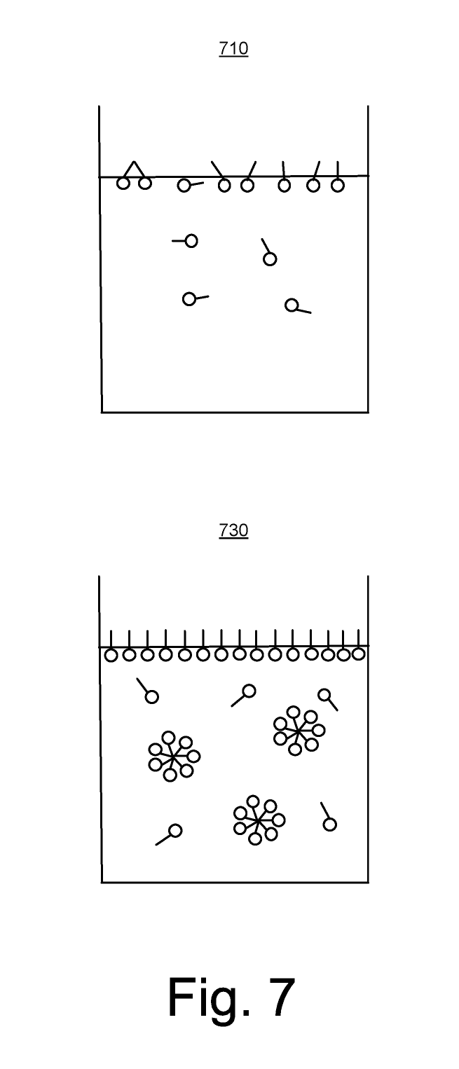

FIG. 7 shows an example of a system 710 prior to micelle formation and an example of a system 730 after micelle formation. The approximation used in a surfactant model can be that the IFT between the oil and water phase is constant at surfactant concentrations below the CMC, and undergoes a sudden drop to the ultra-low regime as the ME forms. In particular, FIG. 7 shows diagrams of distribution of surfactant molecules in solution at concentrations below (see, e.g., the system 710) and above (see, e.g., the system 730) the CMC.

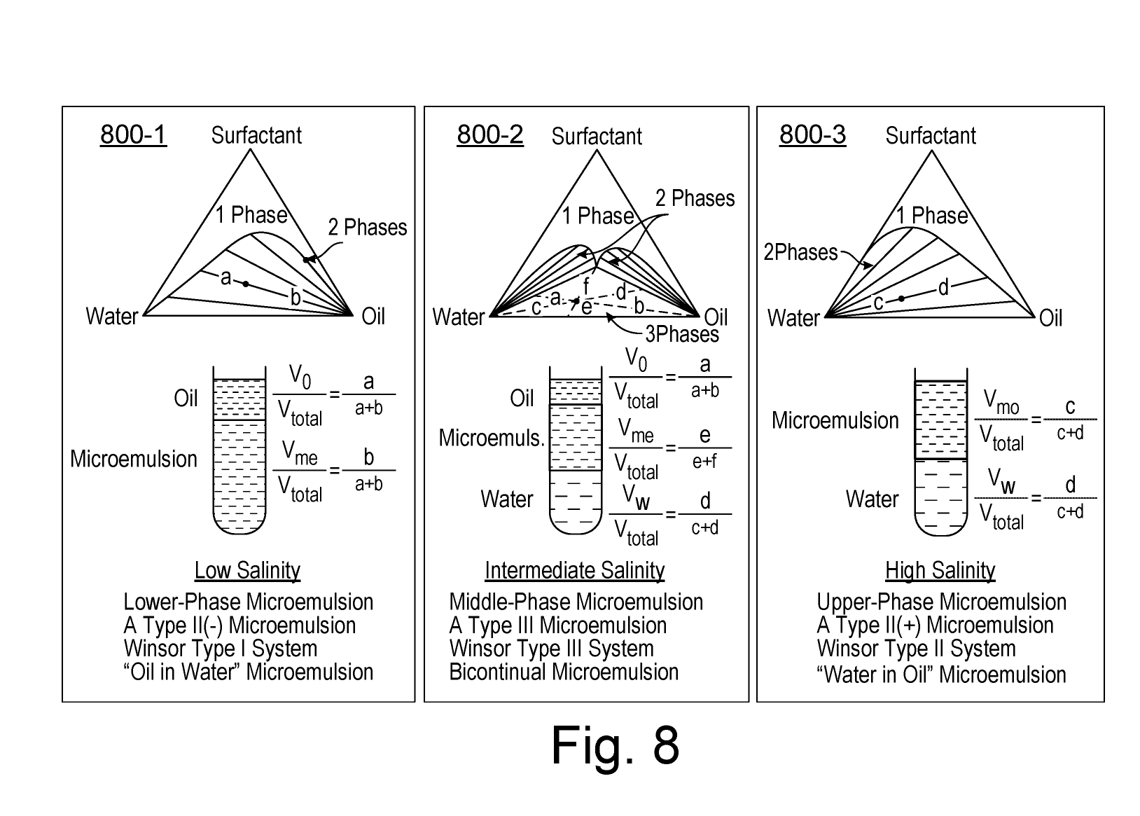

FIG. 8 shows examples of diagrams of phase behavior in the symmetric bi-nodal curve approximation. Once the CMC is exceeded, the phases present in the system will depend on the salinity in the system. For example, the Type II(−) system includes excess oil and water in ME (water molecules surrounded by hydrophilic heads). In simulations with a range of salinities, a system may transition through each of these ME types.

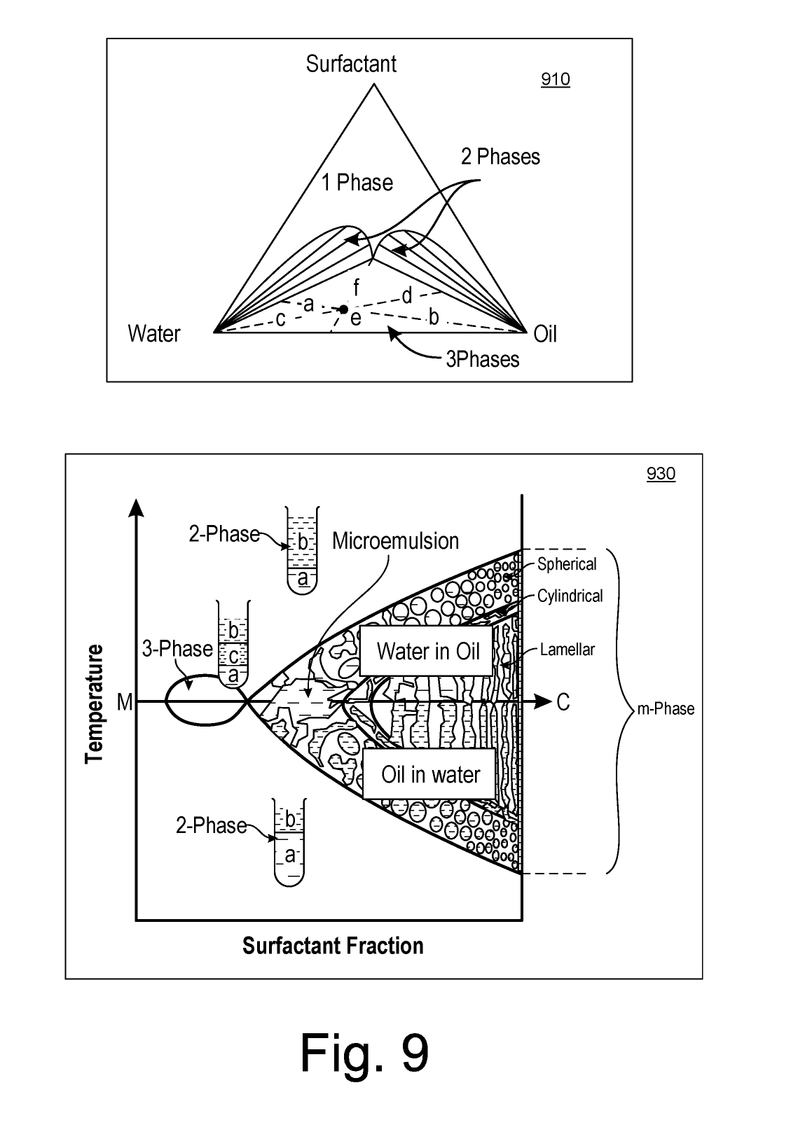

FIG. 9 shows a portion of a diagram of FIG. 8 referred to as a ternary phase diagram 910 and another example diagram 930, referred to as a fish diagram. In such examples, as water increases, physical behavior may progress in the ternary phase diagram 910 in a direction away from oil and toward water. For example, water can be injected into a formation via one or more wells, etc., such that water fraction increases. The diagrams 910 and 930 of FIG. 9 can be temperature dependent and/or dependent on one or more other factors.

Different types of so-called Winsor phase diagrams exist, which can be classified as type I corresponding to a 2-phase region where the surfactant is dissolved mainly in the water phase, type II corresponding to a 2-phase region where the surfactant is dissolved mainly in the oil phase and type III corresponding to a 3-phase region where the surfactant forms a phase of its own between the (bottom) water phase and (top) oil phase.

In the diagram 930, the m-phase region is the region of micelle formation, which may be relatively small (e.g., nanometer size). The m-phase region can be rich in mesophases (e.g., with various morphologies). It may include spherical, cylindrical (also called wormlike) and lamellar micelles depending on temperature range, etc. Structures for these mesophases may correspond to cubic (spherical micelles), hexagonal (cylindrical micelles) and lamellar symmetry respectively. In the diagram 930, the microemulsion may be a bicontinuous phase. Oil-in-water micelles may be obtained at low temperature and “reverse” (water-in-oil) micelles may be obtained at high temperatures. Water-in-oil and oil-in-water micelles can form in the m-phase region. Micelles can also form in the 2-phase region as well. These micelles can be different from those found in the m-phase region and may be formed of surfactant/water (or surfactant/oil). Micelles can form above a critical micelle temperature (CMT) and/or a critical micelle concentration (CMC).

As indicated in FIG. 8, salinity can be a factor as to what phases exist in a system. As an example, a salinity gradient may exist in a formation (e.g., in pore spaces) at one or more times prior to, during and/or after a production operation and/or an injection operation. As salinity changes, a system may move into a three phase region and/or may move out of a three phase region. As an example, salinity and/or temperature can be a factor or factors where ionic surfactants are utilized; noting that temperature may be a factor for non-ionic surfactant systems.

While various examples pertain to multi-phase with a particular number of phases, such as two or three phases, more than three phases may exist and/or a multi-phase system with a phase that is a gas phase. As an example, a method may be implemented with four phases where one of the phases is a gas phase. A multi-phase mode can be a mode of operation that corresponds to appearance of a microemulsion. As an example, a multi-phase operational mode may be a microemulsion operational mode. As an example, a microemulsion operational mode may be implemented responsive to a phase transition from a phase region to a different phase region where, for example, the phase regions may be represented via one or more phase diagrams.

As an example, a method of operating a reservoir simulator can include performing a reservoir simulation based on a spatial reservoir model that represents a subterranean environment that includes a reservoir where, for a portion of the spatial reservoir model, the performing includes utilizing a phase model operational mode; based at least in part on a phase transition in the portion of the spatial reservoir model to another phase region that includes a microemulsion, implementing a microemulsion operational mode; and, based at least in part on a phase transition in the portion of the spatial reservoir model from the other phase region to a different phase region, implementing the phase model operational mode for the portion of the spatial reservoir model.

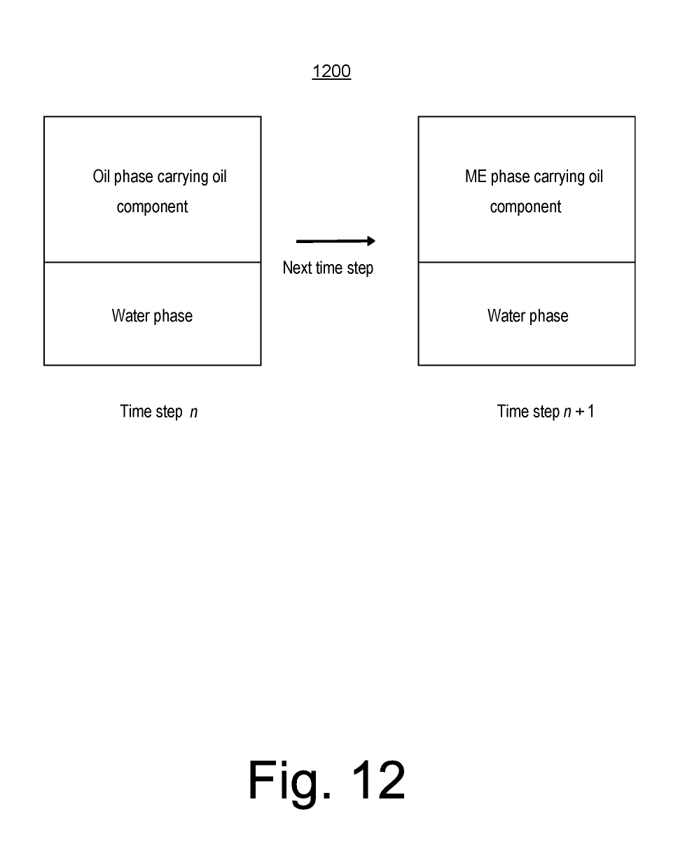

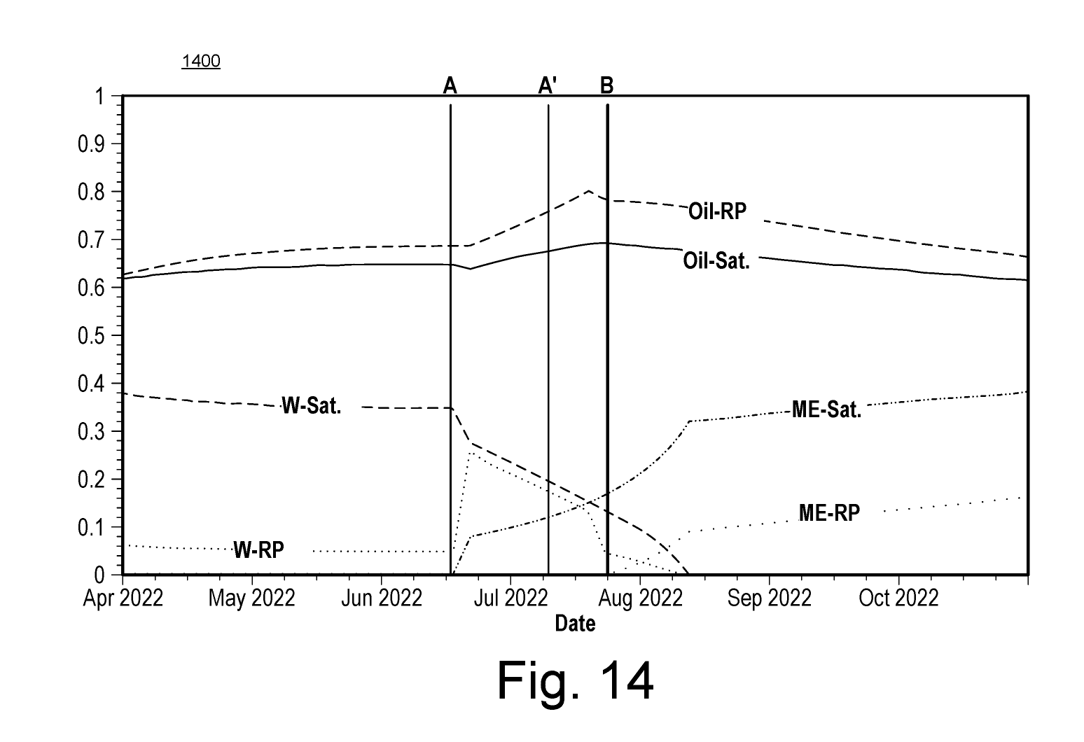

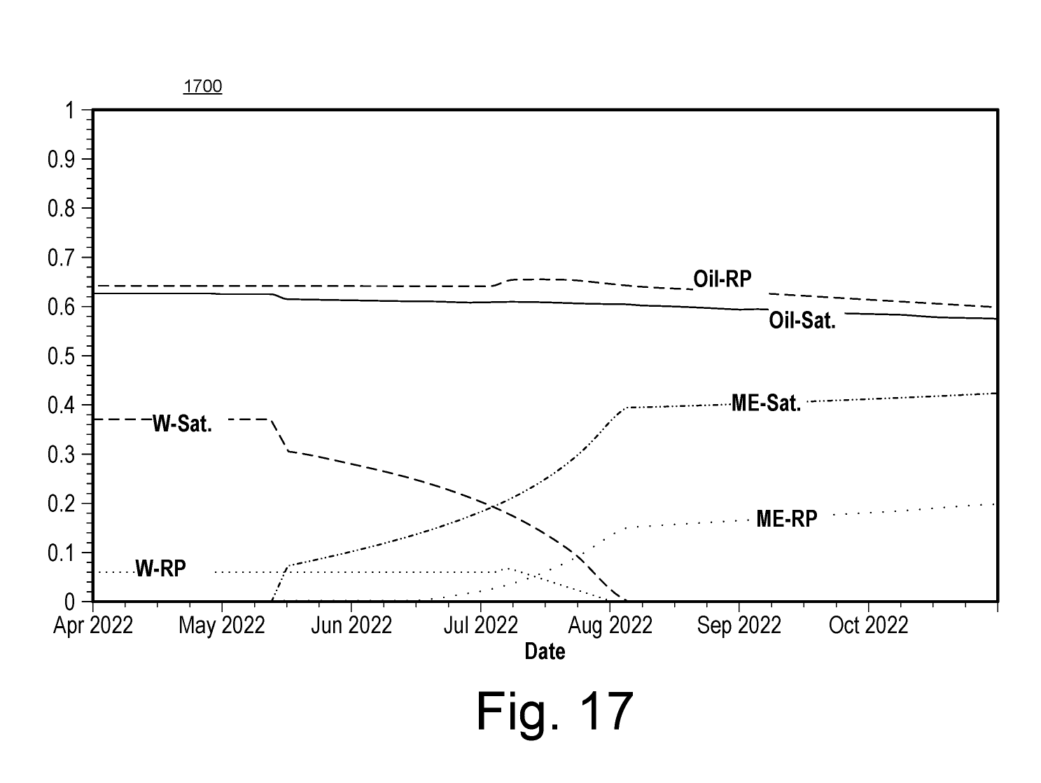

As an example, where a microemulsion forms, it can form with one or more other phases and, for example, may form over time to an extent where a number of other phases decreases. As shown in a method 1200 of FIG. 12 with graphical representations, a water phase may be present at a first time and present at a subsequent second time where at the first time an oil phase carries an oil component and where at the second time, a microemulsion phase is formed and present that carries an oil component. In such an example, at the first time, the phase region can be a first multi-phase region and, at the second time, the phase region can be a second multi-phase region that includes a microemulsion phase, which may, for example, change in one or more manners over time (e.g., a third time, etc.). In such an example, upon a decision that a microemulsion is formed, a method may implement a microemulsion operational mode, which can be a multi-phase operational mode that aims to handle microemulsion formation. In the plot 1400 of FIG. 14, formation of a microemulsion is shown where a number of phases can be discerned prior to the formation of the microemulsion and a number of phases can be discerned after the initial formation of the microemulsion. As shown, water saturation can decrease post-microemulsion formation to, for example, a negligible value. In the plot 1700 of FIG. 17, water saturation is also shown as decreasing to a negligible value after the initial formation of the microemulsion. Again, a number of phases can be discerned before and after the initial formation of the microemulsion where, for example, at the initial formation of the microemulsion, there are multiple phases.

In a reservoir simulator, several parameters can provide for characterizing the mobility of the fluid. As mentioned, one of those parameters is relative permeability. The concept of relative permeabilities can be explained by considering the absolute permeability, which is the capacity of rock to transmit fluid when that fluid is the one present, and is an intrinsic property of the rock. When more than one fluid is present in the rock, the permeability of each phase (effective permeability) is less than the absolute permeability, and in immiscible cases, the sum of the permeabilities of each phase will also be less than the absolute permeability as a result of IFT that exists between the phases. The relative permeability is the permeability of the phase relative to the absolute permeability.

Another parameter is capillary number. The capillary number of fluid is a single number comparing the effect of viscous forces to those of surface and interfacial tension. The residual saturation (e.g., the oil or water remaining in a well-wept permeable medium) may be quantified by the capillary number in a capillary desaturation curve. The residual saturations determine the volume of the phases available to flow in the medium.

As to components, pseudo-components and phases, as an example, a reservoir simulator may consider a maximum number of phases (e.g., three phases, four phases, etc.). For example, consider three phases—water, oil, and microemulsion (noting that in a reservoir simulator gas can also be accounted for as being present) and three components—water, oil, and surfactant (noting that one or more other components can be modelled, which may, for example, affect phase behavior, such as alcohols). Components can reside in different phases, for example, an oil component can be in a separate oil phase as well as part of a microemulsion phase.

As to modeling microemulsion phase dynamics for systems with multiple components in the oil and water phases (and/or multiple surfactant components), the concept of pseudo-components can be utilized. Pseudo-components represent groupings of components.

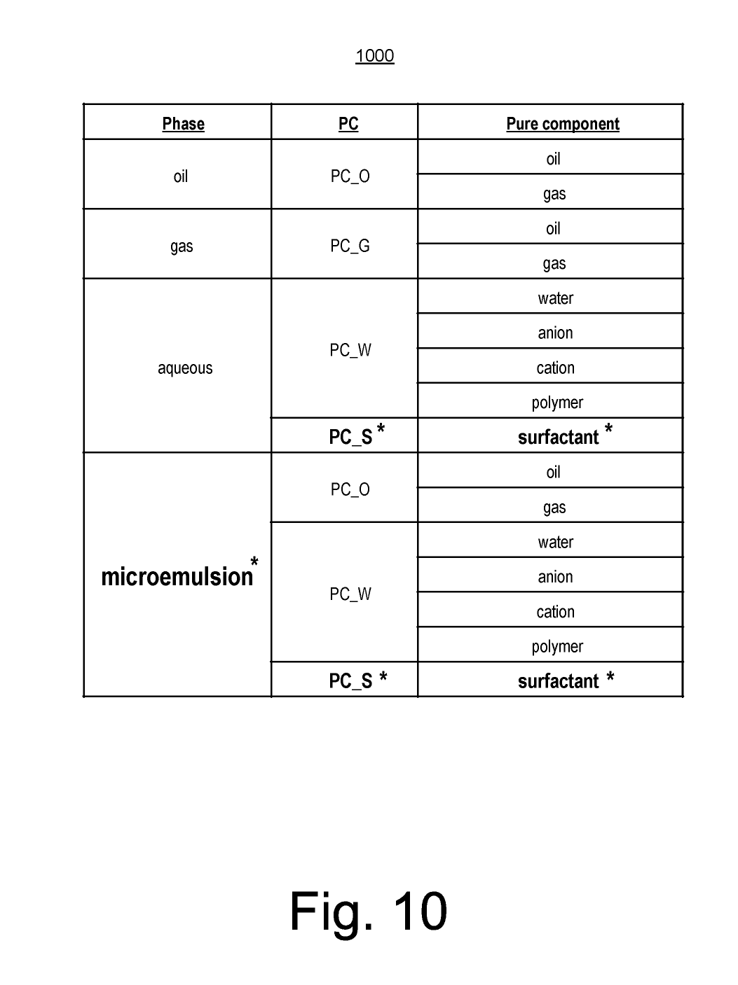

FIG. 10 shows an example of a table 1000 where various pseudo-components are listed. Such a table can represent a component mapping process where pseudo-component layering can facilitate the use of ternary diagrams (e.g., as in FIGS. 8 and 9) for microemulsion phase dynamics in multicomponent systems.

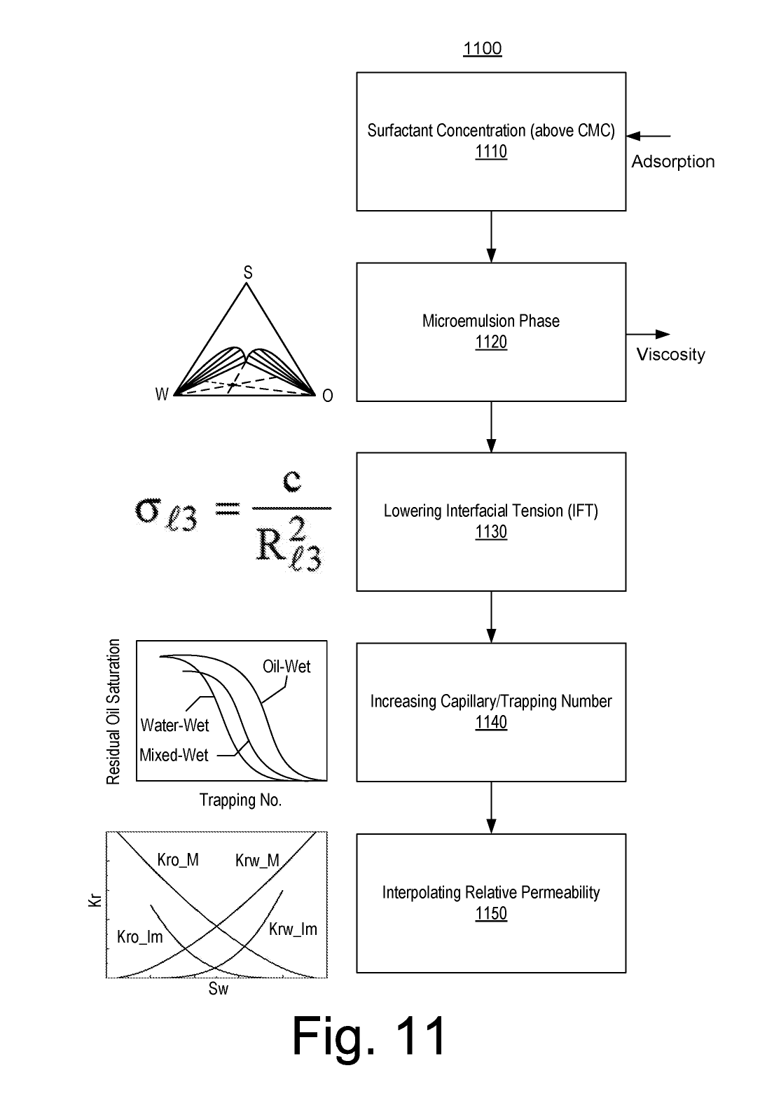

FIG. 11 shows an example of a method 1100, which includes various action blocks 1110, 1120, 1130, 1140 and 1150 that can be utilized, optionally as a sequence of calculations for one grid block (e.g., a grid cell, etc.) that can occur in a reservoir simulator that is configured for modelling surfactant behavior(s). Such a grid block can be for a grid that represents a subterranean region that includes one or more reservoirs. Such a grid can be a reservoir simulator grid that can spatially represent properties in a subterranean region and for which simulation results may be spatially represented (see, e.g., the GUIs 2010 and 2030 of FIG. 20).

As shown in FIG. 11, the block 1110 involves determining the presence of the ME phase by comparing the surfactant concentration to the CMC. In such an example, if the concentration is below the CMC, the ME phase is inhibited, and no phase state change occurs. However, if the CMC is exceeded, the ME phase is deemed to be present. As such, the block 1110 can be a determination and decision block that may be implemented to “check” on one or more grid blocks, grid cells, etc. utilized by a reservoir simulator. For example, such a check can be to spatially determine where an ME phase is present, which can be associated with a time at which the ME phase becomes present. Such information can be utilized, for example, to assess a planned operation, an ongoing operation, a performed operation, etc. As an example, such information may be utilized to control an ongoing operation that aims to generate an ME phase in one or more regions of a reservoir to enhance recovery of oil from the reservoir (e.g., via one or more EOR operations performed by field equipment; see, e.g., the system 2100 of FIG. 21).

In the example of FIG. 11, where the CMC is exceeded (e.g., and/or CMT, etc.), the phase state formed can be classified. For example, per the block 1120, an analysis may be performed to determine if the phase state falls into one of the three ‘Types’ depicted in FIG. 8. As shown in the example of FIG. 11, the block 1120 decides that a microemulsion (ME) phase is present.

With the ME phase present, the block 1130 can utilize new lower IFT values, which are reduced to those in an ultra-low regime. Such an approach can result in a drop in the values of the IFTs by, for example, approximately 5 to approximately 6 orders of magnitude. In such an approach, the IFT values along with the phase viscosity can then be used to determine the capillary number of the fluid, which in turn determines the residual saturations oil and water phases in the system, as shown per block 1140. Often, a drop in IFT is sufficient to allow more oil and water flow than below (e.g., the residual saturation falls). As an example, where a simulator outputs IFT values, one or more controllers may utilize one or more of such values to control one or more pieces of field equipment to perform one or more EOR operations in an enhanced manner, for example, by knowing IFT for a region at a particular time or times.

As an example, there can be more than one cause of a relative permeability discontinuity (discontinuities). For example, consider the following examples: Cause 1: ME phase relative permeability curve may not be matched to appropriate phase; Cause 2: Concept of a displacing phase not clearly defined; Cause 3: CMC as a threshold theory means that the simulator gets a discontinuous jump in S_{M} and IFT; and Cause 4: CMC as a threshold theory leads to a discontinuous jump in IFT.

One or more techniques may be implemented to address one or more of the foregoing causes. As to Cause 2 and Cause 3, consider the relative permeability model implemented in the UTCHEM simulator as given below:

UTCHEM makes use of a Corey-type relative permeability model:

k_{rα}=k_{rα}⁰S̅_{α}ⁿ^{_{α}}

where α represents the phase (O,M,W) and interpolation parameters (between high and low trapping parameters)

$$\begin{matrix}{k}_{r α}^{0} = {k}_{r α}^{0 Low} + \frac{{S}_{{α}^{′} r}^{Low} - {S}_{{α}^{′} r}}{{S}_{{α}^{′} r}^{Low} - {S}_{{α}^{′} r}^{High}} ( {k}_{r α}^{0 High} - {k}_{r α}^{0 Low} ) \\ and & \\ {n}_{r α}^{0} = {n}_{r α}^{ 0 Low} + \frac{{S}_{{α}^{′} r}^{Low} - {S}_{{α}^{′} r}}{{S}_{{α}^{′} r}^{Low} - {S}_{{α}^{′} r}^{High}} ( {n}_{r α}^{0 High} - {n}_{r α}^{0 Low} ) & \end{matrix}$$

Again, α′ is the displacing phase, and S̅_̅{̅α̅}̅ are the volume fractions of fluid available for free flow,

$${\overline{S}}_{α} = \frac{{S}_{α} - {S}_{α r}}{{S}_{F}}$$

here S_{F} is the total fraction of volume for the free flowing fluids,

S_{F}=1−S_{Wr}−S_{Or}−S_{Mr}

The residual saturations are a function of the trapping number N_{Tα}

$${S}_{α r} = min ( {S}_{α} , {S}_{α r}^{High} + \frac{{S}_{α r}^{Low} - {S}_{α r}^{High}}{1 + {T}_{α} {N}_{T α}} )$$

Cause 1: ME phase relative permeability curve may not be matched to proper phase. As explained, the phase behavior associated with ME phase formation and evolution can be quite complex. In a reservoir simulator, the phase state can change from one grid block to the next (see, e.g., grid block model in FIG. 4 and the GUI 2030 of FIG. 20), and as such the phase by which a component travels through grid blocks can change from one grid block to the next.

As mentioned, FIG. 12 shows an example of a method 1200 where changes occur from time step n to time step n+1 of a simulation. In such an example, the oil component can transition from being propagated in the oil phase to being propagated in the ME phase in the space of a single time step due to the appearance of the ME phase in a Type-II+ ME system.

In particular, FIG. 12 shows a schematic of possible phase change affecting components flow through reservoir grid blocks (see, e.g., the GUI 2030 of FIG. 20). A phase state (e.g., phase region) of a particular grid block at time step n can be oil-water and a phase state (e.g., phase region) in the same grid block at time step n+1 is ME-water (Type-II+ ME system). As such, at time step n+1, the grid block has a phase state (e.g., phase region) that is a multi-phase region with a microemulsion (e.g., a microemulsion phase; see, e.g., the m-phase region of the diagram 930 of FIG. 9).

If the oil component mobilities in the oil phase are not matched to those in the ME phase (that is relative permeability of the ME phase is different than that of the oil phase), the oil component mobility will exhibit a jump, leading to a temporal profile.

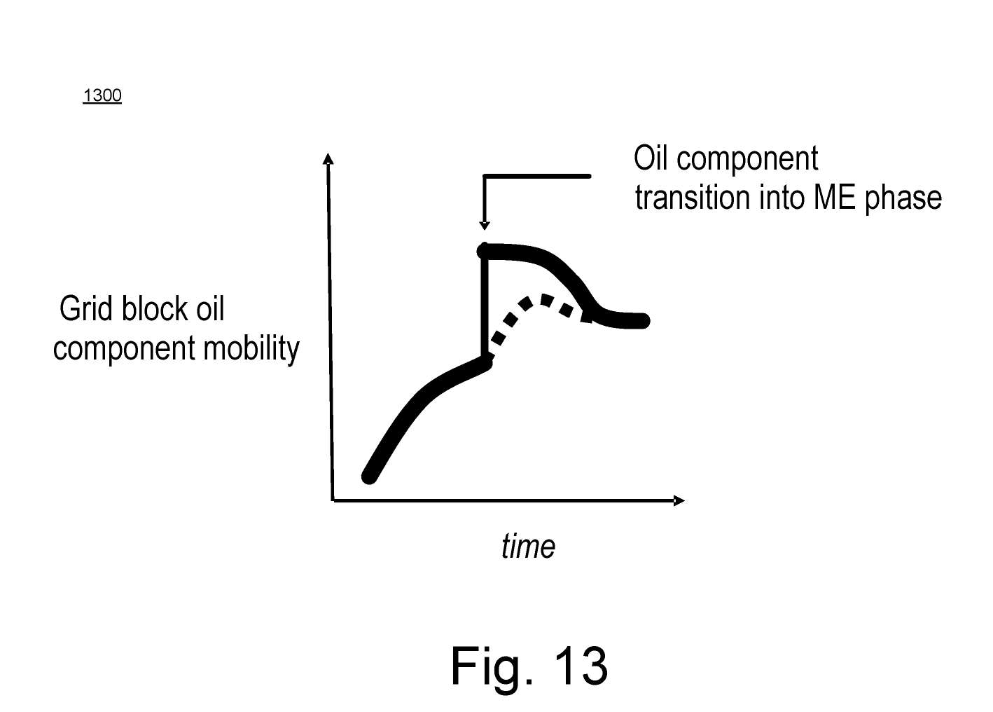

FIG. 13 shows an example plot 1300 of a scenario where a “jump” occurs at a particular time where an oil component transitions into an ME phase. Such a process can be referred to an oil component mobility process; noting that a water component mobility process may occur (e.g., depending on circumstances, etc.).

As shown in FIG. 13, the example time profile of oil component mobility involves the oil component moving in the oil phase with a component mobility given by a curve before transitioning to the ME phase. The dashed black curve denotes a smoothing mechanism for determining the mobility of the ME phase that mitigates potential discontinuities.

As to the situation illustrated in FIG. 13, it may be rectified by calculating ME phase relative permeabilities as some concentration weighted average of the relative permeabilities of the phases present. As an example, a method can include providing parameters to be defined for the ME phase curve (e.g., curve end points). These values can be weighted in proportion to some function of the surfactant concentration in the ME phase, and can be combined with oil and water component concentration average of the oil and water phase values.

Another approach entails determining the ME phase relative permeability curve solely from a concentration weighted average of the oil and water values. Using the example situation depicted in FIGS. 12 and 13, the concentration weighting method can give a relative permeability for the ME phase that is similar to that of the oil phase in the previous time-step (in other words, it can be strongly weighted towards the oil parameter).

As to Cause 2, the concept of a displacing phase not clearly defined, consider an approach where, in a two-phase system, the concept of a displacing phase is clearly defined; where it is the other phase. For example, in an oil-water phase state the oil and water phases can be mutually displacing. In such an example, the relative permeabilities for the phases can then be determined by the values of the saturations of the phases. For example, consider:

kᵣₒ=kᵣₒ(Sₒ,S_{w},\hat{k}_{ow})

k_{rw}=k_{rw}(S_{w},Sₒ,\hat{k}_{wo})

where k_{rα} is the relative permeability for phase α, S_{α} is the saturation of phase, and \hat{k}_{α,α′} represents the relative permeability curve of phase α displaced by phase α′. As an example, \hat{k}_{α,α′} may be in the form of a user defined table, or an equation. As an example, a value may be determined utilizing a model that may be physics based and/or empirical. As an example, in a two-phase system, the above functional form may be reduced further to k_{rα}=k_{rα}(S_{α}, \hat{k}_{αα′}). For analogy with three phase systems, the unreduced functional form can be utilized.

In the case of a three-phase oil-water-ME phase state, the utilized convention set in the IX simulator (and UTCHEM simulator) is to take the ME phase as the displacing phase for the oil and water phases as soon as it appears, regardless of the volume fraction (saturation) of the ME phase. In other words, the relative permeability for oil and water phases exhibits a discontinuous jump

kᵣₒⁿ(Sₒⁿ,S_{w}ⁿ,\hat{k}_{ow}ⁿ)→kᵣₒⁿ⁺¹(Sₒⁿ⁺¹,S_{M}ⁿ⁺¹,\hat{k}_{oM}ⁿ⁺¹)

k_{rw}ⁿ(S_{w}ⁿ,Sₒⁿ,\hat{k}_{wo}ⁿ)→k_{rw}ⁿ⁺¹(S_{w}ⁿ⁺¹,S_{M}ⁿ⁺¹,\hat{k}_{wM}ⁿ⁺¹)

where the superscripts n and n+1 denote the time step level.

For an abrupt transition within one time step from an oil-water system to a Type-II+/Type-II− ME system, where the number of phases is 2, the jump can be made negligible by applying the mitigating measures described in Cause 1. For example, for an abrupt transition from an oil-water system at time-step n to a Type-II+ ME system with excess water at time-step n+1:

Sₒⁿ⁺¹=0

S_{M}ⁿ⁺¹≈Sₒⁿ

S_{w}ⁿ⁺¹≈S_{w}ⁿ

and the methods described above in Cause 1 could be made to help ensure that \hat{k}_{wM}ⁿ⁺¹≈\hat{k}_{wo}ⁿ.

However, for non-abrupt transitions (occurring over a number of time-steps) from an oil-water system to a Type-II+/Type-II− ME system, or for transitions to/from Type-III ME systems, (where the number of phases present is not 2) such assumptions may be prohibited. As such, the logic that using the ME phase as the displacing phase as long as it is present can cause large jumps in the relative permeability from one time-step to the next, for example:

kᵣₒⁿ(Sₒⁿ,S_{w}ⁿ,\hat{k}_{ow}ⁿ)→kᵣₒⁿ⁺¹(Sₒⁿ⁺¹,S_{M}ⁿ⁺¹,\hat{k}_{oM}ⁿ⁺¹)

k_{rw}ⁿ(S_{w}ⁿ,Sₒⁿ,\hat{k}_{wo}ⁿ)→k_{rw}ⁿ⁺¹(S_{w}ⁿ⁺¹,S_{M}ⁿ⁺¹,\hat{k}_{wM}ⁿ⁺¹)

where for transitions to/from three phase systems, in general

Sₒⁿ⁺¹≠0

S_{w}ⁿ⁺¹≠0

S_{M}ⁿ⁺¹≠Sₒⁿ

S_{w}ⁿ⁺¹≠S_{w}ⁿ

As an example of implementation, consider this issue as applied to the relative permeability in the UTCHEM simulator (e.g., UTCHEM simulation model as part of a simulator).

Considering the above example of an oil-water phase state evolving into a three-phase oil-water-ME phase state, the value of k_{rw}⁰ changes from

$${k}_{rw}^{0 , n} = {k}_{rw}^{0 Low} + \frac{{S}_{or}^{Low} - {S}_{or}^{n}}{{S}_{or}^{Low} - {S}_{or}^{High}} ( {k}_{rw}^{0 High} - {k}_{rw}^{0 Low} )$$

in an oil-water phase state at time-step n, to

$${k}_{rw}^{0 , n + 1} = {k}_{rw}^{0 Low} + \frac{{S}_{mr}^{Low} - {S}_{mr}^{n + 1}}{{S}_{mr}^{Low} - {S}_{mr}^{High}} ( {k}_{rw}^{0 High} - {k}_{rw}^{0 Low} )$$

in an oil-water-ME phase state at time-step n+1.

For an abrupt transition to from an oil-water system to an oil-water-ME system, Sₒᵣⁿ≈Sₘᵣⁿ⁺¹, and a smooth evolution of k_{rw}^{0,n+1} to k_{rw}^{0,n+1} can be obtained by ensuring that Sₒᵣ^{Low}≈Sₘᵣ^{Low} and Sₒᵣ^{High}≈Sₘᵣ^{High} by application of the solution in Cause 1.

For non-abrupt transitions (e.g., occurring over a number of time-steps) from an oil-water system to a Type-II+/Type-II− ME system, or for transitions to/from Type-III ME systems, (e.g., where the number of phases present is not 2) the solution provided to Cause 1 can be no longer sufficient to ensure smooth evolution of k_{rw}^{0,n+1} to k_{rw}^{0,n+1}.

As to Cause 3: CMC as a threshold theory leads to a discontinuous jump in S_{M}, consider a method that includes using the CMC as a threshold for the appearance of ME phase, which means that in the time-step that the ME phase first appears, its saturation will not in general be negligible relative to the saturation of the other phases. In the case of an abrupt transition from two phase oil-water to Type I+/− ME system, this discontinuous jump may not cause detrimental issues for the relative permeability. For example, for an abrupt transition from an oil-water system at time-step n to a Type-II+ ME system with excess water at time step n+1 it can be expected that the relative permeability of the water phase under goes through an approximately continuous change:

k_{rw}ⁿ(S_{w}ⁿ,Sₒⁿ,\hat{k}_{wo}ⁿ)→k_{rw}ⁿ⁺¹(S_{w}ⁿ⁺¹,S_{M}ⁿ⁺¹,\hat{k}_{wM}ⁿ⁺¹)

as

Sₒⁿ⁺¹=0

S_{M}ⁿ⁺¹≈Sₒⁿ

S_{w}ⁿ⁺¹≈S_{w}ⁿ

and the methods described above in Cause 1 could be made to ensure that \hat{k}_{wM}ⁿ⁺¹≈\hat{k}_{wo}ⁿ.

However, for non-abrupt transitions (e.g., occurring over a number of time-steps) from an oil-water system to a Type-II+/Type-II− ME system, or for transitions to/from Type-III ME systems, these assumptions may be prohibited. As such, there can be an expectation that the oil and water phase relative permeability to undergo a discontinuous change:

kᵣₒⁿ(Sₒⁿ,S_{w}ⁿ,\hat{k}_{ow}ⁿ)→kᵣₒⁿ⁺¹(Sₒⁿ⁺¹,S_{M}ⁿ⁺¹,\hat{k}_{oM}ⁿ⁺¹)

k_{rw}ⁿ(S_{w}ⁿ,Sₒⁿ,\hat{k}_{wo}ⁿ)→k_{rw}ⁿ⁺¹(S_{w}ⁿ⁺¹,S_{M}ⁿ⁺¹,\hat{k}_{wM}ⁿ⁺¹)

as

Sₒⁿ⁺¹≠0

S_{w}ⁿ⁺¹≠0

S_{M}ⁿ⁺¹≠Sₒⁿ

S_{w}ⁿ⁺¹≠S_{w}ⁿ

Sₒⁿ⁺¹≠Sₒⁿ

In other words, the saturations of the water and oil phases abruptly change to accommodate for the volume fraction of the newly formed ME phase, which, as mentioned, can be present at inception with one or more other phases.

With reference to the relative permeability model present in the UTCHEM simulator, the appearance of a non-negligible ME phase saturation will give rise to discontinuous jumps in S_{αr} and S̅_{α}, leading to discontinuous jumps in the relative permeability of the three phases. As an example, a non-negligible ME phase may be a fraction greater than a pre-determined value such as, for example, 0.01, 0.05, etc.

As to Cause 4: CMC as a threshold theory leads to a discontinuous jump in IFT, as described above the IFT plays a role in the determination of the mobilities of the phases, in that it determines the values the residual saturations. These residual saturations determine the magnitude and extent of the relative permeabilities across the relative permeability curves. A more appropriate functional form for the relative permeability of phase α displaced by phase α′ can be:

k_{rα}=k_{rα}(S_{α},S_{α′},\hat{k}_{αα′},σ_{αα′})

where σ_{αα′} is the IFT between the two phases.

Using the CMC as a threshold for the appearance of ME phase means that in the time-step that the ME phase first appears, the value of σ_{αα′} can drop by approximately 5 to approximately 6 orders of magnitude, causing a large perturbation to the value of the relative permeability.

With reference to the relative permeability model present in the UTCHEM simulator, discontinuous changes in the value of σ_{αα′} will lead to discontinuous changes in the value of S_{αr} (via the trapping number), leading to discontinuous jumps in the relative permeability of the three phases.

Various example methods such as the method 500 of FIG. 5 can improve operation of a reservoir simulator, which can be a reservoir simulator that is part of a system that includes one or more controllers, one or more pieces of field equipment, etc. As explained and shown, for example, as in FIG. 16, a method can be implemented via execution of instructions by a processor of a simulator to reduce error, which can be, for example, error in one or more types of values (e.g., saturation, relative permeability, fraction, oil production rate, etc.) that can be germane to one or more EOR operations.

FIG. 14 shows an example plot 1400 of an example of the discontinuous jumps in the relative permeabilities (RP) for a particular grid block in a 1D simulation. These results were generated with the IX reservoir simulator (INTERSECT® simulator) using Corey-type relative permeabilities with concentrated weighted parameters to mitigate the discontinuities as mentioned. Note that in this case, upon inception/formation of the ME phase, a three-phase oil-water-ME system is present for a number of time-steps before transitioning to a two-phase oil-ME system; noting that the transition to the two-phase oil-ME system (e.g., phase region) occurs over multiple time steps. As shown, the values for water relative permeability (W-RP) and water saturation (W-Sat.) diminish to zero around the date of August 2022 while the values for oil RP (Oil-RP) and oil saturation (Oil-Sat.) as well as ME RP (ME-RP) and ME saturation (ME-Sat.) remain non-zero.

Specifically, FIG. 14 shows time evolutions of saturations (“Sat.”) and relative permeabilities (“RP”) for oil, water, and ME phases in a particular grid block. Vertical lines denote particular time steps of the simulation performed by the simulator. In FIG. 14, times A, A′ and B are illustrated. Such times can be those of the example instructions, functions and/or routines 600 of FIG. 6. For example, time A can be prior to time A′ and B where interpolation occurs from time A′ to B as indicated in the examples of FIG. 6.

As an example, a method can include storing water relative permeability (see, e.g., W-RP) and oil relative permeability (see, e.g., Oil-RP) just prior to a microemulsion (ME) forming. Such a double can be a data structure and may be stored for a location or a cell (e.g., grid cell), etc. Such “backup” values may be utilized for a simulation between times A and A′.

As an example, a method can include making a decision that a microemulsion has formed (e.g., based on one or more criteria). At that time, which may correspond to a time that is a present time, a future time, a past time (e.g., in the physical world), the simulator may consider it to be a present time for purposes of triggering one or more actions. As an example, such a decision can be made for a location (e.g., a grid cell) and/or for multiple locations (e.g., grid cells). As an example, a simulator may store in a data structure to a computer-readable medium values for grid cells (e.g., a double for each grid cell) as to values that existed prior to formation of a microemulsion (e.g., determination as to formation of a microemulsion). As an example, a simulator may, at one or more times, decide to hold one or more values fixed at one or more previous value (e.g., consider a constant relative permeability approach). For example, consider holding relative permeabilities for water and oil constant from times A and A′.

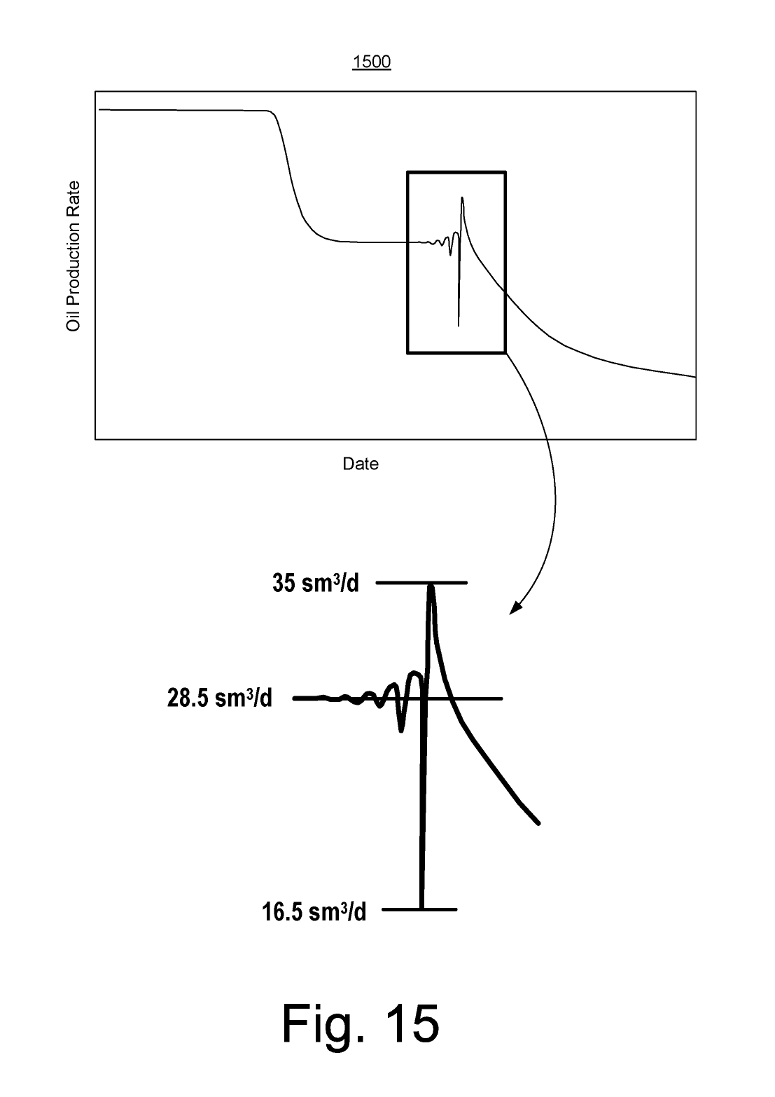

FIG. 15 shows an example plot 1500 that illustrates the impact of a relative permeability profile from the production of oil from the 1D reservoir. Note the large oscillations (errors) in the oil production profile with respect to time, which range from approximately 16.5 standard cubic meters per day (sm³/day) (e.g., about 110 barrels per day) to approximately 35 standard cubic meters per day (e.g., about 220 barrels per day). The origin of these oscillations can be traced to the jumps in the relative permeability shown in the example plot 1400 of FIG. 14. In particular, FIG. 15 shows field oil production rate for an example case with original relative permeability specified for oil and water phases.

These results have been generated using a concentration weighted calculation of the ME phase, to remove the impact of Cause 1 from the results, and with a modification to the method by which the capillary number of the ME phase is calculated such that it is a cross concentration average of the IFT of the oil-ME and water-ME phases.

As explained, various types of surfactant formulations can give rise to interfacial tension (IFT) to enhance the recovery of oil, for example, by reducing trapping effects of capillary forces. As mentioned, surfactant, when mixed with oil, can give rise to microemulsion-type phase behavior where, for example, depending on the surfactant affinity for oil and water, a microemulsion may exist as water-in-oil, oil-in-water, or bicontinuous (or bi-continuous).

Enhanced oil recovery (EOR) can include use of one or more types of surfactants where EOR may aim to address one or more factors that may or may be trending toward unacceptable recovery. Factor may include, for example, one or more of a reduction in well pressure, oil trapping, etc. Subsurface conditions that can impede oil or gas migration may include capillary contrasts in pore throats in a seal versus a reservoir, contrasts in physical/chemical properties of subsurface fluids (e.g., primarily oil, gas, and water), rock/fluid chemical and/or physical interactions, etc.

EOR can include injection of surfactant to a downhole region of the Earth using equipment such as, for example, one or more pumps. As an example, a surfactant can include a chemical that forms a surfactant in a subterranean environment, for example, due to one or more chemical interactions and/or reactions that may occur in a subterranean environment. As an example, a surfactant can be a polymer that becomes a surface active agent responsive to exposure to an alkaline environment. For example, EOR can include injection of polymer as a surfactant where the polymer becomes a surface active agent downhole in a downhole alkaline environment.

As an example, a system may transform from an oil/water phase system to an oil and microemulsion phase system where the microemulsion includes surfactant and mostly water. As mentioned, IFT can be salinity dependent.

As an example, a system may transition from two phases to three phases where one of the phases is a microemulsion phase. Such a transition can, as explained, cause a numerical instability in a reservoir simulator that gives rise to erroneous values over an amount of time. As an example, a system may transition from one phase to two phases where one of the phases is a microemulsion phase. As explained, a system with a microemulsion phase can experience one or more further transitions, which can include a change in amount (e.g., fraction) of a microemulsion phase and/or one or more other phases (e.g., increasing, decreasing, appearing, disappearing, etc.). One or more techniques may be applied to address such a numerical instability in a manner that may facilitate convergence to a solution, which may be a dynamic solution that characterizes behavior of a reservoir. As mentioned, a method such as the method 500 of FIG. 5 may be employed to cause a simulator to operate in an improved manner, for example, with reduced error.

As an example, a simulation may involve a model that includes a number of cells (e.g., grid cells) that may exceed one million cells (e.g., consider a model with 100,000,000 cells) such a model may take considerable time and computational resources to output a solution that characterizes a reservoir. As such, a simulation can represent an amount of time and resources expended where a solution is desired to be accurate. Where a simulation can be of greater accuracy, confidence may be increased in a solution that characterizes a reservoir, particularly where decisions are to be made as to injection, production, equipment development, drilling, etc. As an example, a method may be implemented to improve convergence of a simulator operating according to a spatial model. For example, the method 500 of FIG. 5 may increase the ability of a simulator to converge on a solution (simulation result) at one or more times. Such an improvement can result in a more accurate solution (or even a solution where previously a solution is not found) and do so in lesser computational time (e.g., lesser demand on computational resources).

As an example, at a first time, a method can include storing values in an array (e.g., a data structure) where the first time is prior to microemulsion formation. Such values may be accessed for a period of times to a second time. After the second time, one or more interpolation techniques may be utilized to determine values (e.g., optionally using a fixed value and a dynamic value). After the second time, a third time may occur where a simulator may transition from interpolation to another technique (e.g., full approach as may be prior to the second time, etc.). The approach at the third time may be considered to be dynamic (e.g., full dynamic).

As an example, a method can include deciding when to transition from an interpolation approach to a dynamic approach. Such an approach may be via a predetermined criterion (e.g., an internally stored number) or via a calculated number.

As an example, a dynamic reservoir simulation can include modeling water injection as may be associated with surfactant flooding as a chemical EOR operation. Such an approach may involve one or more cells of a grid cell model of a reservoir transitioning into, for example, a three phase region of a ternary phase diagram. As an example, a salinity gradient may exist as part of a physical reality that can drive a transition.

Transitions can occur that can be described via a ternary phase diagram such as the Type III diagram 910 as in FIG. 9 (see, e.g., triangle as to three-phases with lobes as to two-phase regions and a single microemulsion phase above). What tends to happen, in the field, is that injection of surfactant(s) occurs in the water phase (e.g., surfactant flooding using water as an aqueous carrier medium). If the microemulsion forms, injection of additional water will drive the system toward the water end of the ternary phase diagram. At some point, the system may transition to the two-phase lobe that is the left lobe of the diagram 910 of FIG. 9. If more water is injected, then the system can transition out of the two-phase lobe and emerge as a single phase. As soon as going into the two-phase lobe, the results of a reservoir simulator may be returned to a trusted operational mode; whereas, entry to the three-phase region (e.g., consider entry from the right lobe), can cause a reservoir simulator to operate in an “untrusted” operational mode where calculations as to particular physical phenomena are supplanted at least in part via one or more types of procedures (e.g., accessing stored values and/or interpolation). As explained, a reservoir simulator can be improved by inclusion of operational instructions for decision making as to physical phenomena that can occur in a reservoir being subjected to one or more EOR operations.

As mentioned, a reservoir simulator can refrain from using the full relative permeability curve calculation for the oil and water phases in a period between time points A and B (see, e.g., the plot 1400 of FIG. 14), which may be referred to as t_{A}, t_{A′}, and t_{B}, and implement an approach as follows:
Time t_{A} is chosen to be the time-step immediately prior to the appearance of the ME phase;
Between times t_{A} and t_{A′}, the relative permeabilities for the oil and water phases is held at constant at kᵣₒ^{A}, and k_{rw}^{A}, their values at time t_{A};
Between times t_{A}, and t_{B}, the relative permeabilities for the oil and water phases are calculated by interpolating between their values at A and the value predicted by the original relative permeability calculation k_{rα}=k_{rα}(S_{α}, S_{α′}, \hat{k}_{αα′}, σ_{αα′}); and
After time t_{B} the original relative permeability calculation, via k_{rα}=k_{rα}(S_{α}, S_{α′}, \hat{k}_{αα′}, σ_{αα′}), is again honored.

As an example, a method can include, additionally, adding the following condition on the displacing phase for the oil and water relative permeability calculations:
The ME phase is considered the displacing phase of the oil and water phases if it is mobile.

In terms of mitigating the causes mentioned, by amending the definition of the displacing phase and by the act of holding the relative permeabilities constant at kᵣₒ^{A} and k_{rw}^{A} between times t_{A} and t_{A}, the discontinuous jumps introduced by Causes 2, 3 and 4 can be circumvented. The interpolation back to an original relative permeability calculation between times t_{A}, and t_{B} can help to achieve a relatively smooth transition (e.g., less error) back to an original simulation path once the ME phase is firmly established. It is noted that mitigation can be against more than one of the Causes 2, 3 and 4. As an example, a method can include mitigating Causes 2, 3 and 4 to address relative permeability discontinuities.

A full calculation of the relative permeabilities from the relative permeability curves between the times t_{A} and t_{B} will lead to unphysical jumps, as discussed, thus invalidating the full use of these formulae/tables.

As an example, a method can include modifications as to the relative permeabilities of the ME phase as follows:
The use of a concentration weighted method for defining the relative permeability parameters of the ME phase (as described in Cause 1 in the previous section); and
The method by which the capillary number of the ME phase is calculated is by a cross concentration average of the IFT of the oil-ME and water-ME phases.

Below some examples of methods for calculating the relative permeabilities of the oil and water phases at points A and considerations for calculating the full relative permeability calculation, via k_{rα}=k_{rα}(S_{α}, S_{α′}, \hat{k}_{αα′}, σ_{αα′}) after time t_{A′}, and also a method for interpolating between them at t_{A}, and t_{B}.

As to Point A, consider one or both of the following two example methods for calculating kᵣₒ and k_{rw} at point A.
Example Method 1: The values of kᵣₒ and k_{rw} at the previous time step are stored for each grid block until the ME phase appears. Once the ME appears, the values of kᵣₒ and k_{rw} at the previous time step are no longer stored, and the most recent value is used as the relative permeabilities at point A, kᵣₒ^{A} and k_{rw}^{A}.
Example Method 2: To reduce memory demand (e.g., as to storing two extra floating point numbers per grid block, as per method 1), estimate the value of kᵣₒ^{A} and k_{rw}^{A}.

To estimate the values of k_{rW} and k_{rO} at point A, a method can estimate the values of Sₒ and S_{w} at S_{M}=0. For example, consider the following:

Sₒ^{A}=Sₒⁿ+S_{M}ⁿC_{M,pO}ⁿ

and

S_{w}^{A}=S_{w}ⁿ+S_{M}ⁿC_{M,pw}ⁿ

where C_{M,pc}ⁿ is the concentration of (pseudo-)component pc in the ME phase at time-step n. In other words, we use simple estimates available for the volumetric concentrations of the pseudo components.

Note that more accurate values of S_{O}^{A} and S_{W}^{A} may be determined via a flash calculation. While more accurate, flash calculations tend to be computationally expensive. In addition, the value of S_{M} tends to be small (e.g., but not negligible) initially, when the estimate at point A is most relevant (see interpolation). Without such estimated values of S_{O}^{A} and S_{W}^{A} a good match may be difficult to obtain between the values of the relative permeabilities immediately before and after point A.

As mentioned, as mentioned, a salinity gradient can drive a change. As noted, salinity effects may cause C_{M,pc} to vary. Provided a smooth curve can be produced, such varying may have relatively little effect the relative permeability profiles.

To these estimated values of S_{w}^{A} and Sₒ^{A}, consider, for example, the relations:

S_{M}^{A}=0

and

σ_{α,α′}=σ_{ow}

where σ_{ow} is the value of the IFT between the oil and water phases in the presence of ME phase, which can be assumed to be a constant.

With the foregoing estimates, the values of k_{rw}^{A} and kᵣₒ^{A} can be calculated via the full relative permeability calculation k_{rα}=k_{rα}(S_{α}, S_{α′}, \hat{k}_{αα′}, σ_{αα′}).

As to interpolation methods, as an example, one or more of a number of different methods for interpolating between the values of at t_{A} and the original relative permeability calculation may be utilized.

As an example, consider a linear interpolation of the form (α=w, o)

k_{rα}=k_{rα}^{A}(1−ω)+k_{rα}^{orig}ω

where k_{rα}^{orig}=k_{rα}(S_{α}, S_{α′}, \hat{k}_{αα′}, σ_{αα′}) is the value of the original relative permeability calculation, and

$$\begin{matrix}ω = \frac{{S}_{M} - {S}_{M}^{{A}^{′}}}{{S}_{M}^{B} - {S}_{M}^{{A}^{′}}} & \\ 0 \leq ω \leq 1 & \end{matrix}$$

where S_{Mr} is the residual saturation of the ME phase, and S_{M}^{A′} and S_{M}^{B} may be user input parameters (e.g., or otherwise determined) determining the ME saturation at times t=t_{A}, and t=t_{B}, respectively.

In other words: ω=0 and k_{rα}=k_{rα}^{A} for S_{M}≤S_{M}^{A′} (which defines the period t_{A}≤t≤t_{A′}) and ω=1 and k_{rα}=k_{rα}^{Orig} for S_{M}≥S_{M}^{B} (which defines the period t≥t_{B}).

As to choosing times A, A′ and B, these parameters can be fixed parameters, or they could be dynamically calculated values based on one or more criteria being met.

For fixed parameters, they could be user input or internal values for S_{M}^{A′}. For dynamically calculated values, one example can be to selectively apply the above criteria if the ME containing phase state has three phases (oil-water-ME). In which case the following can be applied:
Time A: dynamically calculated within the simulator to be time that a three phasestate oil-water-ME state forms, for the first appearance of the ME phase for a grid block.
Time A′: dynamically calculated within the simulator to be the time that the phasestate moves from the 3 phase oil-water-ME phase state to a 2 phase state (oil-ME or water-ME)
Time B: internally calculated to give a smooth transition from the fixed values of k_{rα} α=O, W.

The justification for this being that, on exceeding the CMC, if the phase state formed is a 3 phase oil-water-ME system, the discontinuities in the relative permeabilities for the oil and water phases can be much worse than if the phase state formed were a 2 phase oil-ME or water-ME phase state. This is due to the action of the IFT in the Chun-Huh (with Hirasaki) correction model, which assumes that the IFT for the oil-ME and water-ME interfaces fall to a minimum at optimum salinity (which tends to result in 3 phase state systems).

As to example results, consider the comparison between the results obtained with the original relative permeability curve and one or more of the approaches discussed above. The case was run with the following interpolation parameters: S_{M}^{A′}=0.2, S_{M}^{B}=0.2001, i.e. a sharp transition from k_{rα}^{A} to k_{rα}^{orig} once the ME saturation exceeds 0.2. This value has been chosen to coincide with the initial water saturation in the model. The case has a salinity gradient—the reservoir water is at optimum salinity while the injected salinity is at low salinity. The surfactant injection concentration is above the CMC. Other case parameters are shows below in Table 1.

TABLE 1
Example parameters.

| | |
|---|---|
| Number of grid cells | 1 × 40 × 1 |
| Grid size | 200 ft × 25 ft × 200 ft |
| Permeability | 600 mD |
| Porosity | 0.25 |
| Relative | Corey model with following parameters |
| permeability | Residual saturation: 0.2 (W) 0.3 (O) 0.2 (M) |
| | End point relative permeability at low cap number: |
| | 0.3085 (W) 1.0 (O) 0.3085 (M) |
| | End point relative permeability at high cap number: |
| | 1.0 (W) 1.0 (O) 1.0 (M) |
| | Exponent: 1.3 (W) 1.75 (O) 1.3 (M) |
| | CDC parameters: 2000 (W) 60000 (O) 350 (M) |
| Initial conditions | Pressure: 1000 psi |
| | Oil saturation: 0.8 Water saturation: 0.2 |
| Injector well | Water injection: 300 STB/d |
| scenario (1, 40, 1) | |
| Producer well | Constant BHP: 1000 psi |
| scenario (1, 1, 1) | |
| Viscosity | Water: 0.39 cP |
| | Oil: 2.5 cP |

FIG. 16 shows an example plot 1600 that indicates how the new field oil production rate has a smoother profile (less error) than the original, while still honoring the original results in trend to a good degree. As shown in FIG. 16, the span in both positive and negative directions is reduced, which improves the operation of the simulator. As such, the simulator operates with less error and greater certainty. Specifically, for the example of FIG. 16, the reduction in span is from about 19 standard cubic meters per day to about 1.8 standard cubic meters per day, which is an approximate order of magnitude reduction in error.

FIG. 17 shows an example plot 1700 of the new saturation and relative permeability profiles obtained. Discontinuities in the relative permeabilities of the oil and water phase have been successfully overcome (compare to those of the plot 1400 of FIG. 14). The plot 1700 shows time evolutions of saturations and relative permeabilities for oil, water, and ME phases, as labeled, in a particular grid block for the relative permeability model of the multi-phase operational mode or microemulsion operational mode (see, e.g., a grid block of the grid model in the GUI 2030 of FIG. 20).

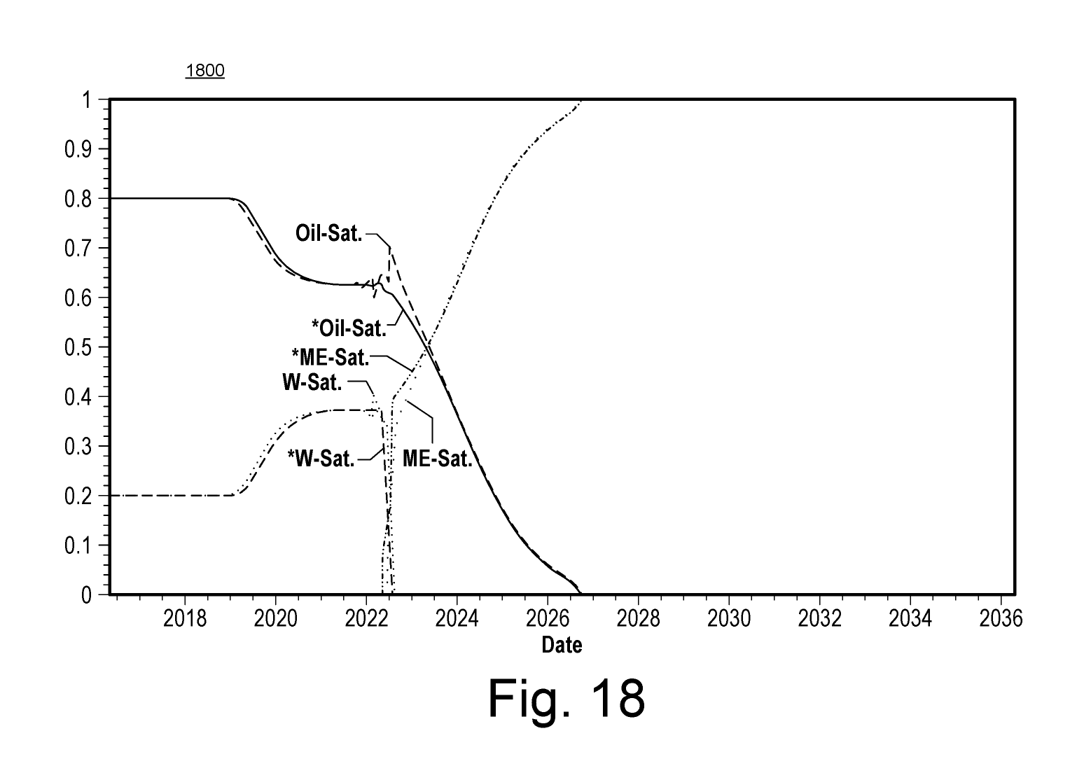

FIG. 18 shows an example plot 1800 as to a comparison between the saturations of the new and original relative permeability for the duration of the simulation. The plot 1800 shows a comparison of the time evolution of the saturations for a particular grid block obtained using the relative permeability model (e.g., of the multi-phase operational mode or microemulsion operational mode) compared the other relative permeability model (see labels).

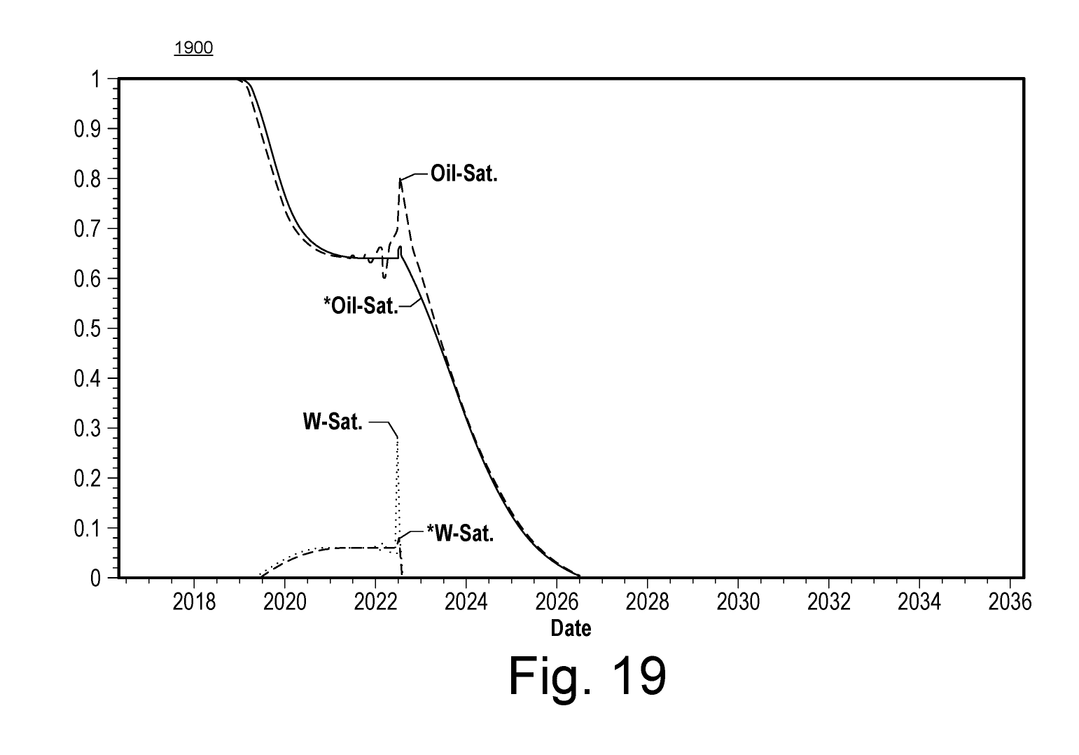

FIG. 19 shows an example plot 1900 of a comparison between the relative permeability of the oil and water phases for the new and original relative permeability for the duration of the simulation. The results show good agreement between the sets of curves away from the ME phase appearance time, and provide further evidence of the success in removing the discontinuities and oscillations from the grid block values. The plot 1900 shows a comparison of the time evolution of the relative permeability for a particular grid block obtained using the relative permeability model (e.g., of the multi-phase operational mode or microemulsion operational mode) compared the other relative permeability model (see labels).

FIG. 20 shows examples of graphical user interfaces (GUIs) 2010 and 2030. A graphical user interface (GUI) is a type of user interface that allows users to interact with electronic devices through various graphics and graphical controls, which can include graphical icons and visual indicators such as secondary notation. A GUI can be structured to perform operations of other types of physical input devices. For example, a GUI can include graphical controls for keys such as keys of a QWERTY keyboard. As such, a GUI is a physical device that allows for human-machine interactions. A typewriter can be built via components such as keys, ribbons, etc. As an example, a GUI can be built using hardware and software components. For example, specialized instructions executable by a processor (e.g., a CPU, GPU, core, microcontroller, etc.) can be executed to cause a rendering of graphics to a display. Such a display may be a touch-screen display with associated touch input circuitry (e.g., via a stylus, a finger, etc.). As an example, a computing system can include a human-machine input device such as a mouse, a touchpad, a trackball, a microphone (for voice input), etc. Such input devices may interact with the computing system to navigate a GUI and/or to select one or more features of the GUI, which may be selectively actuate for purposes of controlling the computing system.

In FIG. 20, the GUIs 2010 and/or 2030 can be rendered to show values or representations of values of a subterranean region of the Earth, which can include a reservoir. As an example, a GUI display can be operatively coupled to a simulator such that values (e.g., spatially distributed values) from the simulator can be utilized to generate visual representations of physical conditions of a field and/or physical phenomena of a field and/or operational control of field equipment. For example, in the GUI 2030, various wells are labeled where the GUI 2030 shows conditions at the wells. Such conditions can include saturations, relative permeabilities, flow rates, fluid compositions, microemulsions, etc. As shown, examples of gas saturation, oil saturation and water saturation are shown. Sub-regions are shown in the GUI 2030 with respect to a grid model of the subterranean region. Such sub-regions correspond to saturations, per values from a simulator. As an example, a controller can be instructed to control one or more field operations based on saturations, which may be matched to real-time for operations in the field. In such an example, a controller can instruct a pump to adjust a pump flow rate of fluid, which may include one or more chemicals, in a manner to alter saturations in the subterranean region. A controller can issue an instruction to a pump at a wellsite of one of the wells labeled in the GUI 2030 to thereby cause the pump to adjust its flow rate of fluid, which can include one or more chemicals. The simulator may be updated responsive to such an adjustment, automatically and/or via user input. In such a workflow, the simulator can determine values for a past, present and/or future time. In such an example, one or more values may be utilized to revise the GUI 2030 and/or to issue one or more additional control instructions.

FIG. 21 shows an example of a system 2100 that includes various types of equipment for performing various types of field operations. The system 2100 may be operatively coupled to a computing system that includes a simulator and that includes a display or displays that can render one or more GUIs such as, for example, one or more of the GUIs 2010 and 2030 of FIG. 20. As an example, the system 2100 may be controllable and controlled by such a computing system, optionally via various GUI inputs.

In the system 2100, various pieces of equipment are shown, which can include electronic equipment such as sensors, actuators, controllers, transmitters, receivers, etc. As an example, a computing system can be operatively coupled to one or more pieces of equipment via wire and/or wireless communication circuitry. As an example, a computing system can include a simulator as a specially programmed computerized framework that can calculate various values for purposes of controlling one or more pieces of field equipment. For example, a simulator can calculate a flow rate, an emulsion type, an emulsion formation time, an emulsion formation region, an interfacial tension, a composition of fluid, etc. Such types of values can be utilized in controlling an injection process that injects chemicals into a subterranean formation that includes a reservoir with oil. As an example, one or more methods can improve recovery of oil from a reservoir by utilizing a simulator that can simulate underground conditions. As an example, such a method may make a tertiary recovery process (e.g., an EOR process) more effective as to amount of oil recovered, rate of oil recovery, amount of oil in produced fluid(s), and/or amount of water and/or chemical utilized.

The system 2100 of FIG. 21 can be utilized for purposes of chemical flooding to add a material (chemical) to water being injected into a reservoir to increase the oil recovery by one or more of (1) increasing the water viscosity (e.g., polymer and/or surfactant floods), (2) decreasing the relative permeability to water (cross-linked polymer and/or surfactant floods), or (3) increasing the relative permeability to oil and decreasing residual oil saturation (Sor) by decreasing the interfacial tension between the oil and water phases (e.g., microemulsion and/or alkaline floods).

FIG. 21 shows an example of a method that includes driving fluid in a subterranean region via injection of water and one or more chemicals via a well or wells 2110, using water as a buffer to protect one or more chemicals 2120, controlling chemical solution mobility 2130 (e.g., via a pump or pumps, etc.), exposing one or more chemicals to an alkaline environment where one or more of the chemicals can form a surface active agent in situ to reduce interfacial tension (IFT) 2140, and recovering additional oil via reduction in IFT via a production well 2150. Such a method can include, for example, a preflush operation that may help to condition a reservoir prior to injection of one or more chemicals 2150.

As shown, the production well in the system 2100 of FIG. 21 can include associated equipment such as a sucker pump and the injection wells can include associated equipment such as injection pumps. Various surface equipment shown in the system 2100 of FIG. 21 can include control equipment, surface processing equipment, collection equipment, computing equipment, reservoir simulator(s), etc.

In FIG. 21, some examples of equipment are labeled, including a well head assembly 2152 of an injection well, an injection pump 2154 operatively coupled to the well head assembly 2152 of the injection well to inject fluid (e.g., water and/or water and chemicals) into the injection well where fluid may be held in one or more tanks as part of surface equipment 2190 to supply the injection pump 2154 and where computerized control equipment 2180 can be operatively coupled to one or more of such surface equipment 2190, well head assembly 2152 and injection pump 2154 to control one or more operations that can include one or more EOR operations.

Also shown in FIG. 21 are a well head assembly 2172 for a production well and a production pump 2174 that is operatively coupled to the well head assembly 2172 to produce fluid(s) from the reservoir as may be subjected to one or more operations, which can include one or more EOR operations. The computerized control equipment 2180 (e.g., as housed in a building, etc.) can be operatively coupled to various equipment including, for example, the well head assembly 2172 and the production pump 2174. As an example, the computerized control equipment 2180 can include one or more simulators and/or be operatively coupled to one or more simulators that can simulate conditions in the reservoir as to one or more of oil, water and microemulsion, which may be formed via use of one or more chemicals. The computerized control equipment 2180 can issue one or more control signals to one or more pieces of equipment using results from a simulator that operates according to a method or methods (see, e.g., the method 500 of FIG. 5). As an example, the computerized control equipment 2180 can include instructions executable to render one or more GUIs such as one or more of the GUIs 2010 and 2030 to a display, which may be a display of the computerized control equipment 2180. For example, the wells in the system 2100 may be represented as wells akin to the wells in the GUI 2030 of FIG. 20 to provide for manual, semi-automated, and/or automated control of one or more pieces of equipment in the system 2100. For example, saturations can be determined for various regions of the reservoir where injection and/or production may be controlled using one or more of those saturations (e.g., in a region or regions). For example, an injection rate of the injection pump 2154 may be adjusted, a production rate of the production pump 2174 may be adjusted (e.g., based on effectiveness of an EOR operation according to a simulator, etc.), a valve in the well head assembly 2152 may be adjusted, a valve in the well head assembly 2172 may be adjusted, an amount of water and/or amount of chemical flowing from a tank or tanks of surface equipment 2190 may be adjusted (e.g., via one or more valves, one or more pumps, etc.), for example, to increase and/or decrease water and/or chemical injected into the reservoir via one or more injection wells. As an example, injection wells may be controlled differently according to regional results from a simulator. Such a simulator-based approach to control can improve one or more EOR operations for the reservoir shown in the example of FIG. 21. As an example, an improvement can be from a simulator that operates with less error and/or more rapidly to thereby allow for control that approaches real-time control for performing one or more EOR operations. As an example, an improvement can be from a simulator that operates with less error as to calculations of oil production rate where one or more pieces of equipment can be controlled in an improved manner (e.g., more accurately) based at least in part on oil production rate to thereby improve one or more EOR operations.

As an example, the computerized control equipment 2180 can include one or more processors, memory that store instructions executable by a processor, and one or more interfaces, which can include interfaces for transmission of information and/or receipt of information from one or more pieces of equipment in the system 2100, which may include one or more sensors, one or more actuators, etc. As an example, the computerized control equipment 2180 can be a controller that issues control information via one or more interfaces to one or more pieces of equipment in the system 2100. As an example, the computerized control equipment 2180 can include one or more of the components of the system 250 of FIG. 2. As an example, the system 100 and/or the geologic environment 150 of FIG. 1 may include one or more of the components of the system 2100 of FIG. 21 and vice versa.

As an example, a controller may aim to expedite recovery of oil, make recovery more efficient, make surface processing more efficient, etc. Such a controller may be operatively coupled to a reservoir simulator that is operated in an improved manner (see, e.g., the plot 1600 of FIG. 16 and the plot 1900 of FIG. 19) where the reservoir simulator includes instructions that are stored in memory and executable by one or more processors to provide an improved reservoir simulator.

As an example, chemical additives to reduce interfacial tension can be utilized that are detergent type compounds such as, for example, petroleum sulfonates and/or other chemicals. An operation can be controlled at least in part via use of a simulator, which can help to minimizing amount of chemicals to achieve a desired change in interfacial tension and/or mobility ratio.

As an example, a simulator can help to control a process via one or more actions, which may include preceding chemical injection with a preflush to buffer the chemicals from reactions with the in situ water and following the chemical injection with the injection of a polymer solution to maintain a favorable mobility ratio for the flood. As an example, a simulator may account for chemicals that are surface active and that, due to such properties, interact with one or more types of rock (e.g., reservoir rock). For example, a chemical can have an affinity for one or more types of minerals found in reservoirs, causing adsorption of chemicals from solution onto the rock in various quantities. A simulator can estimate subsurface conditions and can control one or more pieces of equipment, optionally in real-time and optionally with feedback data as acquired by one or more sensors that are subsurface and/or one or more sensors associated with producing fluid and/or processing fluid (e.g., consider determinations as to water fraction, oil fraction, state of chemicals, microemulsions, etc.).

As an example, a method can include performing a reservoir simulation based on a spatial reservoir model that represents a subterranean environment that includes a reservoir where, for a portion of the spatial reservoir model, the performing includes utilizing a phase model operational mode; based at least in part on a phase transition in the portion of the spatial reservoir model to a multi-phase region that includes a microemulsion, implementing a multi-phase operational mode; and, based at least in part on a phase transition in the portion of the spatial reservoir model from the multi-phase region to a different phase region, implementing the phase model operational mode for the portion of the spatial reservoir model. In such an example, the multi-phase operational mode can include a constant relative permeability time period and/or an interpolation time period.

As an example, a method can include performing a dynamic reservoir simulation.

As an example, a multi-phase region can be a region of a ternary phase diagram. For example, consider a ternary phase diagram that is an oil, water and surfactant phase diagram.

As an example, a salinity gradient can exist in the spatial reservoir model, as may occur in a reservoir that the model represents. In such an example, a transition to a multi-phase region may depend at least in part on the salinity gradient.

As an example, a multi-phase operational mode can include at least three times (e.g., as parameters that can trigger one or more actions). For example, consider an approximate time prior to emergence of the multi-phase region that includes a microemulsion, an approximate time of emergence of the multi-phase region that includes the microemulsion and an approximate time of transition of the multi-phase region that includes the microemulsion to a different phase region.

As an example, a method can include injecting water and surfactant based at least in part on a reservoir simulation (e.g., simulation results). In such an example, a controller may receive information from a simulator such that actions can be controlled in a field operation or operations. Such actions may be one or more of those associated with a chemical EOR operation.

As an example, a method can include performing surfactant flooding based at least in part on a reservoir simulation. As an example, a method can include determining production rate of a reservoir based at least in part on a reservoir simulation. As an example, a method can include building a spatial reservoir model based at least in part on survey data. For example, consider survey data that includes seismic survey data of a subterranean environment.

As an example, a method can include determining one or more transitions, for example, for one or more portions of reservoir, optionally simultaneously.

As an example, a method can include generating simulation results for a spatial reservoir model that represents a subterranean environment that includes a reservoir and rendering a graphical user interface to a display that includes a graphical representation of the reservoir that includes representations of the simulation results being spatially distributed in the reservoir. As an example, a method can include generating simulation results for a spatial reservoir model that represents a subterranean environment that includes a reservoir and, using the simulation results, controlling at least one piece of equipment for fluid injection to the reservoir and/or controlling at least one piece of equipment for fluid production from the reservoir.

As an example, a system can include a processor; memory operatively coupled to the processor; and processor-executable instructions stored in the memory to instruct the system, the instructions including instructions to: perform a reservoir simulation based on a spatial reservoir model that represents a subterranean environment that includes a reservoir where, for a portion of the spatial reservoir model, the reservoir simulation utilizes a phase model operational mode; based at least in part on a phase transition in the portion of the spatial reservoir model to a multi-phase region that includes a microemulsion, implement a multi-phase operational mode; and, based at least in part on a phase transition in the portion of the spatial reservoir model from the multi-phase region to a different phase region, implement the phase model operational mode for the portion of the spatial reservoir model.

As an example, one or more computer-readable storage media can include computer-executable instructions to instruct a computer, the instructions including instructions to: perform a reservoir simulation based on a spatial reservoir model that represents a subterranean environment that includes a reservoir where, for a portion of the spatial reservoir model, the reservoir simulation utilizes a phase model operational mode; based at least in part on a phase transition in the portion of the spatial reservoir model to a multi-phase region that includes a microemulsion, implement a multi-phase operational mode; and, based at least in part on a phase transition in the portion of the spatial reservoir model from the multi-phase region to a different phase region, implement the phase model operational mode for the portion of the spatial reservoir model.

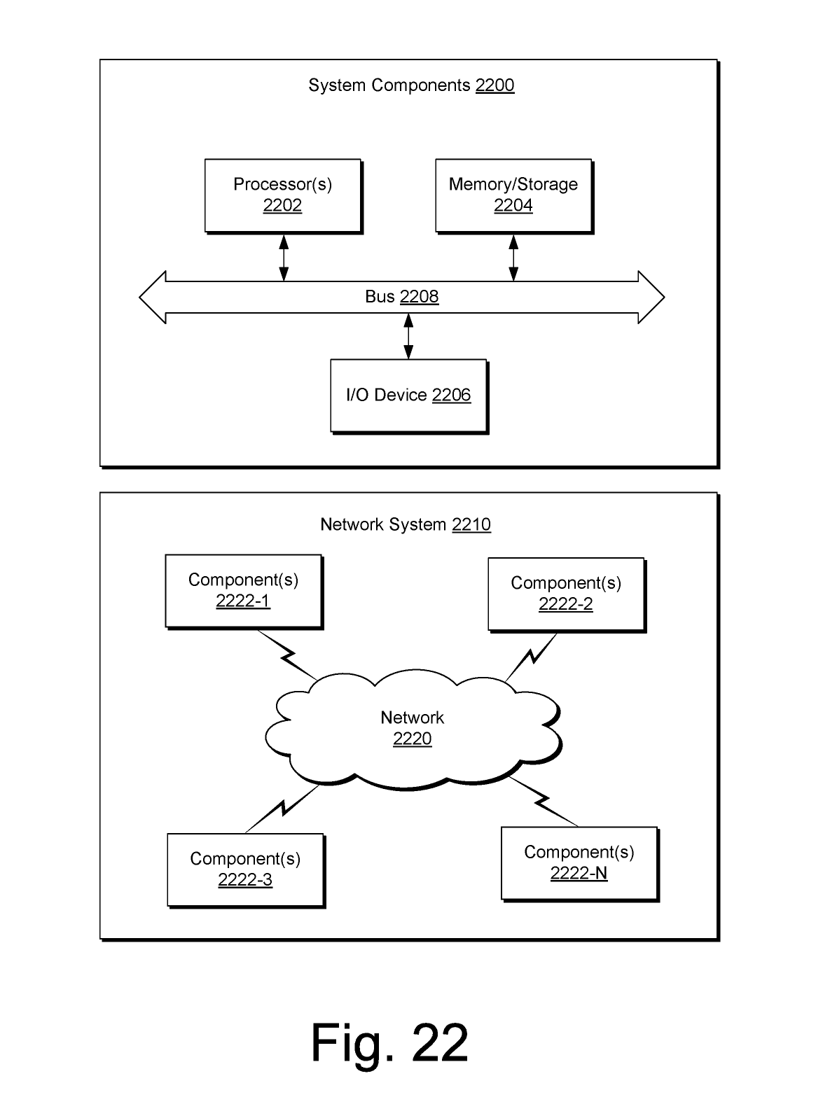

FIG. 22 shows components of an example of a computing system 2200 and an example of a networked system 2210. The system 2200 includes one or more processors 2202, memory and/or storage components 2204, one or more input and/or output devices 2206 and a bus 2208. In an example embodiment, instructions may be stored in one or more computer-readable media (e.g., memory/storage components 2204). Such instructions may be read by one or more processors (e.g., the processor(s) 2202) via a communication bus (e.g., the bus 2208), which may be wired or wireless. The one or more processors may execute such instructions to implement (wholly or in part) one or more attributes (e.g., as part of a method). A user may view output from and interact with a process via an I/O device (e.g., the device 2206). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 2210. The network system 2210 includes components 2222-1, 2222-2, 2222-3, . . . 2222-N. For example, the components 2222-1 may include the processor(s) 2202 while the component(s) 2222-3 may include memory accessible by the processor(s) 2202. Further, the component(s) 2202-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words “means for” together with an associated function.

What is claimed is:

1. A method of operating a reservoir simulator comprising:
performing a reservoir simulation based on a spatial reservoir model that represents a subterranean environment that comprises a reservoir wherein, for a portion of the spatial reservoir model, the performing comprises utilizing a phase model operational mode;
based at least in part on a phase transition in the portion of the spatial reservoir model to a multi-phase region that comprises a microemulsion, implementing a multi-phase operational mode; and
based at least in part on a phase transition in the portion of the spatial reservoir model from the multi-phase region to a different phase region, implementing the phase model operational mode for the portion of the spatial reservoir model.

2. The method of claim 1 wherein the multi-phase operational mode comprises a constant relative permeability time period.

3. The method of claim 1 wherein the multi-phase operational mode comprises an interpolation time period.

4. The method of claim 1 wherein the performing comprises performing a dynamic reservoir simulation.

5. The method of claim 1 wherein the multi-phase region comprises a region of a ternary phase diagram.

6. The method of claim 5 wherein the ternary phase diagram comprises an oil, water and surfactant phase diagram.

7. The method of claim 1 wherein a salinity gradient exists in the spatial reservoir model.

8. The method of claim 7 wherein the transition to a multi-phase region depends at least in part on the salinity gradient.

9. The method of claim 1 wherein the multi-phase operational mode comprises at least three times.

10. The method of claim 9 wherein the at least three times comprise an approximate time prior to emergence of the multi-phase region that comprises the microemulsion, an approximate time of emergence of the multi-phase region that comprises the microemulsion and an approximate time of transition of the multi-phase region that comprises the microemulsion to a different phase region.

11. The method of claim 1 comprising injecting water and surfactant based at least in part on the reservoir simulation.

12. The method of claim 1 comprising performing surfactant flooding based at least in part on the reservoir simulation.

13. The method of claim 1 comprising determining production rate of the reservoir based at least in part on the reservoir simulation.

14. The method of claim 1 comprising building the spatial reservoir model based at least in part on survey data.

15. The method of claim 14 wherein the survey data comprises seismic survey data of the subterranean environment.

16. The method of claim 1 comprising determining the transitions.

17. The method of claim 1 comprising generating simulation results for the spatial reservoir model that represents the subterranean environment that comprises the reservoir and rendering a graphical user interface to a display that comprises a graphical representation of the reservoir that includes representations of the simulation results being spatially distributed in the reservoir.

18. The method of claim 1 comprising generating simulation results for the spatial reservoir model that represents the subterranean environment that comprises the reservoir and, using the simulation results, controlling at least one piece of equipment for fluid injection to the reservoir and/or controlling at least one piece of equipment for fluid production from the reservoir.

19. A system comprising:
a processor;
memory operatively coupled to the processor; and
processor-executable instructions stored in the memory to instruct the system, the instructions comprising instructions to:
perform a reservoir simulation based on a spatial reservoir model that represents a subterranean environment that comprises a reservoir wherein, for a portion of the spatial reservoir model, the reservoir simulation utilizes a phase model operational mode;
based at least in part on a phase transition in the portion of the spatial reservoir model to a multi-phase region that comprises a microemulsion, implement a multi-phase operational mode; and
based at least in part on a phase transition in the portion of the spatial reservoir model from the multi-phase region to a different phase region, implement the phase model operational mode for the portion of the spatial reservoir model.

20. One or more computer-readable storage media comprising computer-executable instructions to instruct a computer, the instructions comprising instructions to:
perform a reservoir simulation based on a spatial reservoir model that represents a subterranean environment that comprises a reservoir wherein, for a portion of the spatial reservoir model, the reservoir simulation utilizes a phase model operational mode;
based at least in part on a phase transition in the portion of the spatial reservoir model to a multi-phase region that comprises a microemulsion, implement a multi-phase operational mode; and
based at least in part on a phase transition in the portion of the spatial reservoir model from the multi-phase region to a different phase region, implement the phase model operational mode for the portion of the spatial reservoir model.
